(19) United States
(12) Patent Application Publication
(10) Pub. No.: US 2020/0187516 A1
(43) Pub. Date: Jun. 18, 2020

(54) Method and Product for Hydrolysis of Lactose in Dairy Compositions

(71) Applicant: PEPSICO, INC., Purchase, NY (US)

(72) Inventors: Susan Lawlor, Little Island (IE); Patrick Maher, Little Island (IE); David McDonagh, Little Island (IE); Maksim N. Omarov, Little Island (IE)

(21) Appl. No.: 16/692,310

(22) Filed: Nov. 22, 2019

Related U.S. Application Data
(60) Provisional application No. 62/781,417, filed on Dec. 18, 2018.

(51) Int. Cl. A23C 9/12; A23C 9/127; A23C 9/133; A23C 9/18

(52) U.S. Cl. CPC A23C 9/1206; A23C 9/18; A23C 9/133; A23C 9/1275

(57) ABSTRACT

A dairy product comprising a sweetened dairy composition with a mass ratio of lactose to glucose equal to 1.0:2.7 to 2.6:1.5 and a mass ratio of lactose to galactose equal to 1.0:2.2 to 2.6:1.1. In a second aspect, a method comprises hydrolyzing lactose in the starting dairy composition in a lactase-catalyzed hydrolysis reaction and deactivating the reaction to provide a lactose percent conversion of 46 to 80 wt. %. In a third aspect, a dairy product comprises a fermented sweetened dairy composition comprising a lactose:glucose mass ratio of 0.01:2.4 to 1.0:1.0 and a lactose:galactose mass ratio of 0.01:2.7 to 1.0:1.0. In a fourth aspect, a method comprises hydrolyzing and fermenting lactose in a starting dairy composition, thereby providing a fermented sweetened dairy composition with a lactose percent conversion of 80 to 100 wt. %.

This application claims priority to U.S. Application No. 62/781,417 filed Dec. 18, 2018, the entire contents of which are incorporated herein by reference.

### BACKGROUND

In a first aspect, the present invention relates to the controlled, incomplete hydrolysis of a starting dairy composition comprising dairy products. For example, the starting dairy composition can be partially hydrolyzed to form a sweetened dairy composition with increased sweetness using components that are inherent in the dairy products. The sweetened dairy composition can then be used in a product formulation. Furthermore, the degree of hydrolysis used to form the sweetened dairy composition can be selected to avoid off-flavors and sensations that occur in products made using a greater degree of hydrolysis, for example, lactose-free or nearly lactose-free products. In a second aspect, the present invention relates to reducing or eliminating added sugar in a product, for example, a sweetened dairy composition or product formulation, while still providing the product with a desired degree of sweetness. In a third aspect, the present invention relates to fermentation and hydrolysis of a starting dairy composition to provide a product, for example, a hydrolyzed and fermented dairy product, which can have a low pH and which can avoid undesirable organoleptic properties, for example, undesired flavors or sensations. In a fourth aspect, the present invention relates to reducing or eliminating added sugar in a product, for example, a sweetened dairy composition, a fermented sweetened dairy composition or product formulation, while providing a desired degree of sweetness. In a fifth aspect, the present invention relates to hydrolysis of lactose in a dairy base to provide a sweetened dairy composition with increased inherent sweetness, thereby reducing or eliminating the need to add sweetener to a finished dairy product made using the sweetened dairy composition.

Many consumers desire sweet-tasting dairy products. Conventionally, the desired degree of sweetness has been obtained with the use of an added sweetener, for example, added sucrose. However, added sweeteners, especially those with preferred organoleptic properties, can increase the caloric content, carbohydrate content, and glycemic index of the resulting dairy product. Some consumers would prefer to avoid one or more of these effects. Although alternative sweeteners exist, they can result in off-tastes, be relatively expensive, or be undesirable to consumers for other reasons. Accordingly, when producing a dairy product, the present inventors have determined that it can be desirable to reduce or eliminate the addition of sugar (e.g., sucrose) and alternative sweeteners (e.g., steviol glycosides, xylitol, non-nutritive sweeteners, or a combination thereof).

Additionally, some consumers enjoy the taste of dairy products but have some degree of lactose intolerance. Although lactose-free and nearly lactose-free products are available for these consumers, for example, through the use of commercially available lactase enzymes, the inventors have noticed that some of these products have undesirable sensory characteristics as a result of the complete or nearly complete lactose hydrolysis process used to produce these products. Advantageously, the inventors have discovered processes and products in which less desirable or undesirable sensory experiences can be mitigated or avoided. As a further advantage, the processes and products can be made using commercially available enzymes that might otherwise result in less desirable or undesirable sensory experiences.

### SUMMARY

In a first aspect, the present invention provides a dairy product comprising a sweetened dairy composition. The sweetened dairy composition comprises lactose, glucose and galactose. The mass ratio of lactose to glucose in the sweetened dairy composition is from 1.0:2.7 to 2.6:1.5, and the mass ratio of lactose to galactose in the sweetened dairy composition is 1.0:2.2 to 2.6:1.1.

In a second aspect, the present invention provides a method for increasing a sweetness of a starting dairy composition, thereby providing a dairy product comprising a sweetened dairy composition. The method comprises several steps. A first step comprises providing a starting dairy composition comprising lactose. A second step comprises hydrolyzing the lactose in the starting dairy composition in a lactase-catalyzed hydrolysis reaction that converts lactose to glucose and galactose. A third step comprises deactivating the lactase-catalyzed hydrolysis reaction before completion, thereby providing the sweetened dairy composition with a lactose percent conversion equal to 46 to 80 wt. %.

In a third aspect, the present invention provides a dairy product comprising a fermented sweetened dairy composition. The fermented sweetened dairy composition comprises a mass ratio of lactose:glucose equal to 0.01:2.4 to 1.0:1.0 and a mass ratio of lactose:galactose equal to 0.01:2.7 to 1.0:1.0.

In a fourth aspect, the present invention provides a method for providing a dairy product that comprises a fermented sweetened dairy composition. The method comprises: providing a starting dairy composition comprising lactose; hydrolyzing the lactose in the starting dairy composition in a lactase-catalyzed hydrolysis reaction that converts lactose to glucose and galactose; and fermenting lactose in the starting dairy composition. The hydrolysis and the fermentation provide the fermented sweetened dairy composition with a lactose percent conversion equal to 80 to 100 wt. %.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic flow chart illustrating an embodiment of a method for making a sweetened dairy composition from a starting dairy composition comprising lactose.

FIG. 2 is a schematic flow chart illustrating an embodiment of a method for making a fermented sweetened dairy composition from a starting dairy composition comprising lactose.

FIG. 3 is a graph showing mass concentrations of lactose, glucose, and galactose in grams per 100 mL of a dairy composition, showing how the mass concentrations vary in time, showing how the overall sensorial experience of the dairy composition changes with the conversion of lactose to glucose and galactose, and showing an optimum in overall sensorial experience as determined by a taste panel being reached after approximately 65 wt. % of the initial lactose has been converted to glucose and galactose.

### DESCRIPTION

Dairy Product Comprising a Sweetened Dairy Composition

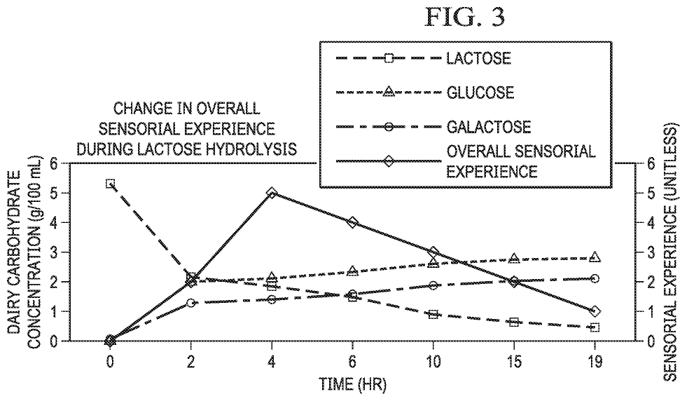

In order to increase the sweetness of a product without adding sweeteners, the inventors conceived of converting lactose to glucose and galactose. As a result of this process, two sugar molecules, glucose and galactose, are formed from each lactose molecule. Additionally, each newly formed molecule of glucose and galactose is individually sweeter than the lactose molecule that it came from. Accordingly, the inventors initially believed that optimal and maximum increased sweetness for a dairy product could be achieved by completely hydrolyzing the lactose in a starting dairy composition to glucose and galactose. Surprisingly, however, the inventors realized that the maximum number-concentration (e.g., mole-concentration) of glucose & galactose molecules did not necessarily correspond to optimum sensorial experience in terms of a desired set of organoleptic properties. Rather an optimum in organoleptic properties, and in particular, “overall sensorial experience” as defined below, was actually achieved when the hydrolysis reaction was stopped well-before completion. An example of optimal “overall sensorial experience” being achieved at approximately 65 wt. % conversion of lactose to glucose and galactose is illustrated in FIG. 3. As used herein organoleptic properties include all perceptions related to food, including aroma, tastes (e.g., sweetness, bitterness, sourness, saltiness, and umami), sounds, images (e.g., color) and sensations, for example, astringency, dryness, texture, smoothness, grittiness, crunchiness, or a combination thereof With respect to the present application, the inventors found that smells, tastes and sensations where particularly relevant to the acceptability of a dairy product subject to lactase-catalyzed hydrolysis of lactose. As used herein, “overall sensorial experience” of a product (e.g., sweetened dairy composition or product formulation) made from a starting dairy composition is defined as a perceived overall sensorial experience of the product to a human. Additionally, in some embodiments, the overall sensorial experience of a product is deemed to be enhanced if and only if the perceived sweetness of the product increases relative to the starting dairy composition and the perceived increase in sweetness is not accompanied by a perceptible increase in astringency or dryness relative to the starting dairy composition.” Accordingly, in such an embodiment, the “overall sensorial experience” of a product can be enhanced (i.e., increased in desirability) as sweetness increases until astringency or dryness begins to increase perceptibly. However, once astringency or dryness begins to increase perceptibly relative to the starting dairy composition, the product's overall sensorial experience would no longer be enhanced as defined. Thus, the optimal overall sensorial experience can occur after perceived sweetness has increased and immediately before increases in astringency or dryness become perceptible.

Without wishing to be bound by theory, the inventors believe that the unexpected result of optimum organoleptic properties occurring at less than the maximum number-concentration of sugar molecules in a product may potentially occur due to the production of by-products (e.g., proteins, peptides, amino acids or a combination thereof), which cause off-flavors (e.g., bitterness) or potentially undesirable sensations (e.g., astringency or dryness) that counteract the increasing number-concentration (e.g., mole-concentration) of sweet-tasting compounds caused by hydrolysis. The inventors believe that these off-flavors, off-sensations, or a combination thereof initially increase at a relatively slow rate or are initially below a threshold level for human perception. Accordingly, the increased sweetness caused by the sweet-tasting compounds initially prevails and the overall sensorial experience of the dairy composition is initially enhanced. However, at some point, the by-products and/or off-flavors begin to dominate or reach a threshold level for human perception, resulting in a potentially less desirable consumer sensory experience, for example, a less desirable combination of organoleptic properties, a decrease in perceived sweetness, increase in off-flavors, increase in undesirable sensations, increase in dryness, increase in astringency, or some combination thereof. Accordingly, the inventors have discovered that a more desirable combination of organoleptic properties, for example, an enhanced overall sensorial experience can be achieved by stopping the hydrolysis reaction at a desired percent completion that is significantly less than 100% completion.

As a person having ordinary skill in the art would understand upon reading the present disclosure, a sweetened composition (including fermented sweetened dairy compositions) produced by enhancing the sweetness of a starting dairy composition without adding sweeteners can provide many advantages as is or incorporated into a dairy product (e.g., a product formulation). For example, the amount of added sugar used in a product (e.g., food, beverage, dairy composition, or a combination thereof) comprising the sweetened dairy composition can be reduced or eliminated. As an illustration, in some embodiments of a product including the sweetened dairy composition, an added amount of sucrose that would increase the sucrose concentration in the product by up to 1 or 2 g Sucrose per 100 g aqueous solution including the sweetened dairy composition can be avoided. Yet, as a result of using of the sweetened dairy composition in the dairy product, the dairy product can deliver a similar sensory experience relative to a product that does not include the sweetened dairy composition but does include the added amount of sucrose. For example, the organoleptic properties of the two products can be similar, both products can have characteristics including a similar perceived sweetness and/or overall sensorial experience, both products can have characteristics including avoidance of undesirable sensations (e.g., astringency or dryness), or both products can deliver a desirable combination of these characteristics.

As another advantage, in some embodiments, the dairy product can be manufactured using existing equipment for handling, making, producing and packaging dairy products, for example, milks, powdered milk, flavored milks, flavored milk drinks, fermented milk drinks, fermented spoonable dairy products, drinkable yogurt, spoonable yogurt, squeezable yogurt, yogurt in a cup, yogurt in a bowl, yogurt in a pouch, powders, flavored powders, hydrated powders, ready-to-mix powdered beverages, or ready-to-mix powdered, flavored beverages.

Additionally, in some embodiments, the dairy product (e.g., sweetened dairy composition) can form the basis of or be incorporated directly into an existing food or beverage formulation (e.g., a milk, flavored milk, milk shake, ice cream, yogurt, or powdered drink mix, etc.) that requires milk to directly reduce the concentration of an added sweetener (e.g., non-nutritive sweeteners, nutritive sweeteners, stevia, sugar, sucrose, fructose, high fructose corn syrup, or a combination thereof) used in the food or beverage formulation while providing the same sweetness or overall sensorial experience that would be present in the food or beverage if the sweetener were included.

Furthermore, in some embodiments, the enzymatically catalyzed hydrolysis reaction used to make a dairy product (e.g., sweetened dairy composition) proceeds slowly enough that once a desired degree of enhanced sweetness or overall sensorial experience is achieved for the dairy product, the desired degree of enhanced sweetness, overall sensorial experience and/or other desired organoleptic properties will persist for a desired amount of time as the reaction proceeds. This can enable the reaction to be stopped or the product to be transferred from a reaction vessel before the desired degree of enhanced sweetness or overall sensorial experience is counteracted by the development other less desired organoleptic properties, thereby negatively impacting a person's overall sensory enjoyment of the resultant dairy product, for example, as indicated by overall sensorial experience of the resultant dairy product. After achieving the desired degree of enhanced sweetness or overall sensorial experience, a desirably slow reaction rate can be useful for commercial production of a dairy product in large batches, which can require a significant amount of time to change temperature, undergo enzyme deactivation, stop a reaction in the batch, or move the batch from one unit to another.

Additionally, in some embodiments, the dairy product (e.g., sweetened dairy composition or product formulation) or the starting dairy composition, or a combination thereof, are provided at a temperature equal to at least 0, 1, 2, 3, or 4° C. and up to 10, 9, 8, 7 or 6° C. or around 4° C. As an example, this can be useful to avoid microbial growth and spoilage before enzymatic hydrolysis, during enzymatic hydrolysis, after enzymatic hydrolysis, or a combination thereof.

As another potential advantage, in some embodiments, the dairy products (e.g., sweetened dairy compositions or product formulations) can have a neutral pH (e.g., 6 to 8, 6.5 to 7.5, 6.75 to 7.25) while providing reduced lactose, which is in contrast, for example, to yogurt, which can provide reduced lactose content but also reduces the pH as a result of the production of lactic acid. Additionally, yogurt can require a lower pH to avoid spoilage.

Also, in some embodiments, the inventors expect that the conversion of lactose (GI=46) to glucose (GI=100) and galactose (GI=23) will have little impact on the glycemic index (GI) of milk (GI=about 32-41), which is already a relatively low glycemic index food (e.g., having a GI of less than 55). Meanwhile, adding sucrose (GI=65) while also leaving the lactose in the milk, would be expected to raise the glycemic index of milk. Accordingly, replacing a portion of added sucrose with glucose and galactose derived from the lactose in milk may potentially result in a dairy product with a relatively lower glycemic index.

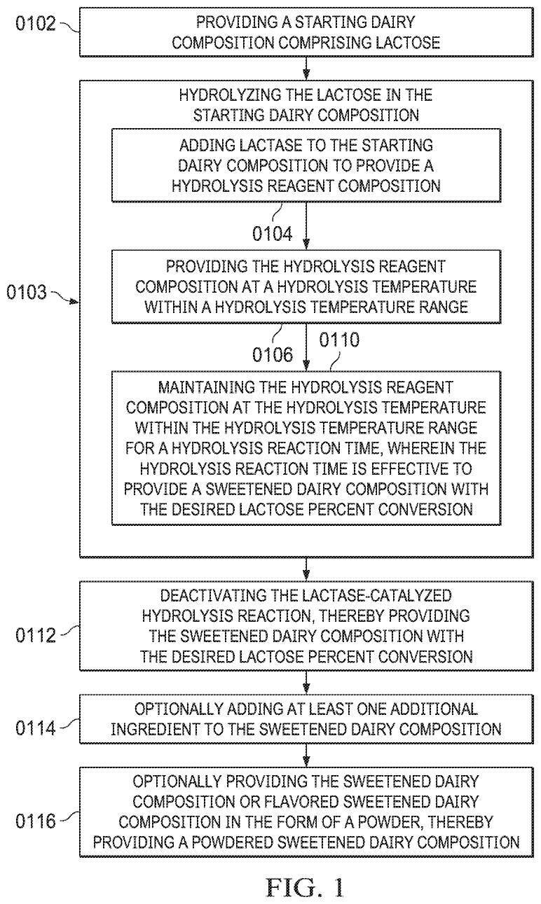

As another potential advantage, in some embodiments the dairy products (e.g., sweetened dairy composition, or product formulation) described herein can be concentrated to provide powdered dairy concentrates. For example, this can reduce water activity to help avoid spoilage, avoid expenses associated with handling and shipping heavier and/or bulkier compositions. Turning to FIG. 1, an embodiment of a method for increasing the sweetness of a starting dairy composition will now be described. As illustrated, the method provides a dairy product comprising a sweetened dairy composition, and the method comprises several steps.

A first step comprises providing 0102 the starting dairy composition (e.g., milk) comprising lactose.

A second step comprises hydrolyzing 0103 the lactose in the starting dairy composition in a lactase-catalyzed hydrolysis reaction that converts lactose to glucose and galactose.

A third step comprises deactivating 0112 the lactase-catalyzed hydrolysis reaction before completion of the lactase-catalyzed hydrolysis reaction, thereby providing the sweetened dairy composition with a lactose percent conversion equal to at least 43, 44, 45, 46, 47, 48, 49, 50, 51, 52, 53, 54, 55, 56, 57, 58, 59, 60, 61, 62, 63, 64 or 65 wt. %, no more than 81, 80, 79, 78, 77, 76, 75, 74, 73, 72, 71, 70, 69, 68, 67, 66 or 65 wt. %, or a combination thereof. In some embodiments, the sweetened dairy composition is provided with a lactose percent conversion equal to 43 to 81 wt. %, 46 to 80 wt. % or 47 to 80 wt. %, 48 to 80 wt. %, 48 to 75 wt. %, 50 to 70 wt. %, or 55 to 69 wt. %, 60 to 69 wt. %, or 46 to 48 wt. %.

In some embodiments, the lactase is allowed to hydrolyze the lactose in the starting dairy composition over a hydrolysis reaction time equal to at least 1, 2, 3, 4, 5, 6, 7, 8, 9, 10, 11, 12, or 13 hours, no more than 14, 13, 12, 11, 10, 9, 8, 7, 6, 5, 4, 3 or 2 hours, or a combination thereof. The hydrolysis reaction time is selected in order to convert 60 wt. % (can be 40 to 65 wt. % or 50 to 77 wt. %) of the lactose to glucose and galactose.

An optional fourth step comprises adding 0114 at least one additional ingredient to the sweetened dairy composition. The at least one additional ingredient can be, but is not limited to, any ingredient described elsewhere in this application, skim milk powder, whey powder, milk proteins, milk protein concentrate, sugar, sucrose, flavor, fruit, fruit preparation, cocoa, coffee, chocolate, a flavor, a plurality of flavors, natural flavor, stabilizer, a food acid, or a combination thereof. The at least one additional ingredient or ingredients can be added to the starting dairy composition after the lactase-catalyzed hydrolysis of the lactose in the starting dairy composition.

An optional fifth step comprises providing 0116 the sweetened dairy composition in the form of a powder, thereby providing a powdered sweetened dairy composition. As examples, the sweetened dairy composition can be provided in the form of a powder using any appropriate technique, including those used for providing milk or other dairy products in the form of a powder. After reading this specification, a person having ordinary skill in the art would be able to determine which processes could be successfully used to provide the powdered sweetened dairy composition. For example, the sweetened dairy composition can be dried, spray-dried, or roller dried (e.g., on a rotating drum), and subsequently granulated, agglomerated, instantized, and milled or subjected to a subset of being granulated, being agglomerated, and being instantized, or a combination thereof.

In some embodiments, the second step of hydrolyzing 0103 the lactose in the starting dairy composition comprises subsidiary steps. A first subsidiary step comprises adding 0104 lactase to the starting dairy composition to provide a hydrolysis reagent composition comprising the starting dairy composition and the lactase.

Essentially any commercially available lactase enzyme can be used for making the sweetened dairy composition. In selecting a lactase enzyme for use in the processes of the present disclosure, it can be preferable to avoid lactase enzymes with side activity (e.g. activity catalyzing reactions other than the hydrolysis of lactose), which can be caused by enzymes other than lactase. For example, lactase can comprise beta-D-galactosidase enzymes produced by fermentation of selected strains of Kluyveromyces lactis. In some embodiments the hydrolysis reagent composition comprises 0.01 to 1.0 wt. % lactase-containing composition or 0.01 to 0.15 wt. % lactase-containing composition. In some embodiments, the hydrolysis reagent composition comprises at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition and optionally up to 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition.

In some embodiments, the lactase-containing composition comprises 1 to 10 wt. % lactase. In some embodiments, the lactase-containing composition comprises at least 1, 2, 3, 4, 5, 6, 7, 8 or 9 wt. % lactase and optionally up to 10, 9, 8, 7, 6, 5, 4, 3 or 2 wt. % lactase.

In some embodiments, the hydrolysis reagent composition comprises at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase and optionally up to 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase.

In some embodiments, it can be preferable to provide the hydrolysis reagent composition with a desired enzyme activity so that the lactase in the hydrolysis reagent hydrolyzes lactose at a desired rate in terms of moles per unit time. In some embodiments, the lactase-containing composition has an activity equal to 2,500 to 65,000 enzyme units per milliliter of the lactase-containing composition (U/mL) at 25° C., equivalent to 41,675 to 1,083,550 nanokatal per milliliter of the lactase-containing composition (nkat/mL) at 25° C. In some embodiments the lactase-containing composition has an activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/mL at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/mL at 25° C.; or a combination thereof (an activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/mL at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/mL at 25° C.; or a combination thereof). In some embodiments, the density of the lactase-containing composition can be approximately 1.0 g/mL. In some embodiments, the lactase-containing composition has an activity equal to 2,500 to 65,000 enzyme units per gram of the lactase-containing composition (U/g) at 25° C., equivalent to 41,675 to 1,083,550 nanokatal per gram of the lactase-containing composition (nkat/g) at 25° C. In some embodiments the lactase-containing composition has an activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/g at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/g at 25° C.; or a combination thereof (an activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/g at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/g at 25° C.; or a combination thereof). As used for lactase enzyme, 1 U is the amount of lactase enzyme that catalyzes the conversion of 1 micro-mole of lactose per minute at 25° C., and at a pH value and lactose concentration that provides the maximum lactose hydrolysis rate. As used for lactase enzyme, 1 katal is the amount of lactase enzyme that catalyzes the conversion of 1 mole of lactose per second at 25° C., and at a pH value and lactose concentration that provides the maximum lactose hydrolysis rate for the lactase enzyme. Accordingly, 1 U is approximately equivalent to 16.67 nkatal.

In some embodiments, the lactase-containing composition has an activity equal to 2500 to 65,000 Lactase Units per gram of the lactase-containing composition, where one lactase unit is the quantity of enzyme that catalyzes hydrolysis to liberate 1 μmol/minute of o-nitrophenol from an o-nitrophenyl-β-D-galactopyranoside substrate at a pH of 4.5 and at a temperature equal to at least 28, 29, 30, 31, 32, 33, 34, 35, 36, 37, 38, 39, 40, 41, 42, or 43° C. and no more than 43, 42, 41, 40, 39, 38, 37, 36, 35, 34, 33, 32, 31, 30, 29, or 28° C., for example, at 37° C. The rate of hydrolysis can be measured using a spectrophotometer.

In some embodiments, the lactase is a beta-D-galactosidase.

A second subsidiary step comprises providing 0106 the hydrolysis reagent composition at a hydrolysis temperature within a hydrolysis temperature range, for example, 1 to 10° C., although other temperatures can also be useful depending on the lactase enzyme used.

A third subsidiary step comprises maintaining 0110 the hydrolysis reagent composition within the hydrolysis temperature range for a hydrolysis reaction time, which is effective to provide the sweetened dairy composition with the desired lactose percent conversion.

In some embodiments, optionally adding 0114 at least one additional ingredient (e.g., sugar, sucrose, flavor, fruit, fruit preparation, grain (e.g., cereal), cocoa, chocolate, a flavor, a plurality of flavors, natural flavor, stabilizer, a food acid, or a combination thereof) to the starting dairy composition occurs after another step (e.g., immediately after the step and before other subsequent steps described herein). For example, the other step can be deactivating 0112 the lactase-catalyzed hydrolysis reaction.

Adding 0104 lactase to the starting dairy composition can also occur before, while or before and while maintaining 0110 the starting dairy composition or the hydrolysis reagent composition within the hydrolysis temperature range for a hydrolysis reaction time. For example, lactase can be added to the starting dairy composition before heating the hydrolysis reagent composition to the hydrolysis temperature range. In some embodiments, it can be useful to control the hydrolysis reaction by controlling the concentration of enzyme in the hydrolysis reagent composition and the temperature of the hydrolysis reagent composition. As another example, lactase can be added to the starting dairy composition while heating the starting dairy composition (and any lactase that has already been added to the starting dairy composition) to the hydrolysis temperature range.

As a further example, lactase can be added to the starting dairy composition after heating the starting dairy composition (and any lactase that has already been added to the starting dairy composition) to the lactase hydrolysis reaction temperature. This could be useful if the start of the lactose hydrolysis reaction is to be controlled by the addition of the enzyme. Under these circumstances, it can be desirable to first heat the dairy composition to a desired reaction temperature so that the lactose hydrolysis reaction will begin immediately upon the addition of the lactase.

In some embodiments, deactivating 0112 the lactase-catalyzed hydrolysis reaction comprises deactivating the lactase by heating the sweetened dairy composition to (i) at least 60, 61, 62, 63, 64, 65, 66, 67, 68, 69, 70, 71, 72, 73, 74, 75, 76, 77, 78, 79, 80, 81, 82, 83, 84, 85, 86, 87, or 88° C., (ii) no more than 105, 100, 95, 90, 89, 88, 87, 86, 85, 84, 83, 82, 81, 80, 79, 78, 77, 76, 75, 74, 73, 72, 71, 70, 69, 68, 67, 66, 65, 64, or 63° C., or (iii) a combination thereof. The sweetened dairy composition can be maintained within a selected temperature range or at a selected temperature for (i) at least 0.5, 1, 2, 3, 4, 5, 6, 7, 8, 9, 10, 20, 25, 30, 35, 40 or 60 seconds, (ii) at least 1, 2, 3, 4, 5, 6, 7, 8, 9, 10, 15, 20, 25, or 30 minutes, (iii) no more than 35, 30, 25, 20, 15, 10, 9, 8, 7, 6, 5, 4, 3, 2 or 1 minutes, (iv) no more than 60, 55, 50, 45, 40, 35, 30, 25, 20, 15, 10, 9, 8, 7, 6, 5, 4, 3, 2, 1.5 or 1 seconds, (v) for 25 to 35 minutes, for 20-40 or 25-35 seconds, or for 0.5 to 1.5 seconds, or (vi) a combination thereof. For example, the heating can be useful to stop the lactase-catalyzed hydrolysis of the lactose, thereby providing the dairy composition with the lactose percent conversion that is desired. As a skilled person would understand, deactivation can be provided by a combination of exposing the lactase enzyme to a higher temperature for a shorter time or by a combination of exposing the lactase enzyme to a lower temperature for a longer time. As an illustration, a composition comprising the lactase enzyme can be maintained at a relatively lower temperature, for example, about 63° C., for about 30 minutes to accomplish deactivation. As another illustration, a composition comprising the lactase enzyme can be maintained at a higher temperature, for example, about 72° C., for about 30 second to accomplish deactivation. Meanwhile, a composition comprising the lactase enzyme can be maintained at a still higher temperature, for example, about 88° C., for about 1 second to accomplish deactivation.

As can be seen, with reference to the present disclosure, the rate of lactose hydrolysis achieved can be controlled using factors including the mole concentration of lactose in a hydrolysis reagent composition, the mole concentration of lactase in a hydrolysis reagent composition, the enzyme activity of the lactase in the lactase-containing composition used to provide the lactase, the mole concentration of lactose hydrolysis products in the hydrolysis reagent composition, the temperature of the hydrolysis reagent composition, and the pH of the hydrolysis reagent composition. Furthermore, the ultimate percent conversion of lactose hydrolysis reaction in a hydrolysis reagent composition can be controlled by changing the rate of lactose hydrolysis or changing the time that the hydrolysis reagent composition is subject to the rate of lactose hydrolysis. In some embodiments, it can be desirable to provide a lactose hydrolysis reaction rate that is configured (e.g., purposefully faster or slower) to match daily or weekly production schedules.

As a skilled person would understand after reading the present disclosure, the inventors contemplate the production of many products comprising a sweetened dairy composition. For example, in one embodiment a dairy product comprises a sweetened dairy composition; a product formulation; or a combination thereof. Examples of product formulations include: milks, flavored milks, milk shakes, breakfast drinks, protein drinks, shakes, protein shakes or other dairy beverages or flavored dairy beverages.

Furthermore, in some embodiments, the dairy product (e.g., the sweetened dairy composition or dairy product comprising the sweetened dairy composition) comprises a mass ratio of lactose:glucose:galactose equal to 1.0-2.6:1.5-2.7:1.1-2.2. In some embodiments, the dairy product comprises a mass ratio of lactose to glucose equal to 1.0:2.7 to 2.6:1.5. In some embodiments, the dairy product comprises a mass ratio of lactose to galactose equal to 1.0:2.2 to 2.6:1.1. In some embodiments, the dairy product comprises 1.0 to 2.6 wt. % lactose, 1.5 to 2.7 wt. % glucose, and 1.1 to 2.2 wt. % galactose. In some embodiments, after treating a starting dairy composition with lactase to provide a sweetened dairy composition, the sweetened dairy composition can comprise 2.5 to 10 wt. % or 3.0 to 10.0 wt. % protein, from 0 to 5 wt. % fat, from 1.0 to 2.6 wt. % lactose, and from 8.0 to 11.0, 8.0 to 14.0 or 8.0 to 15.0 wt. % milk solids, non-fat. Accordingly, in some embodiments, the dairy product (e.g., sweetened dairy composition) comprises 2.5 to 10 wt. % or 3.0 to 10.0 wt. % protein, 0 to 5 wt. % fat, 1.0 to 2.6 wt. % lactose, 8 to 14 wt. % or 8 to 11 wt. % milk solids, non-fat (MSNF), or a combination thereof.

Additionally, the dairy product can have a relatively neutral pH (e.g., 6 to 8, 6.5 to 7.5, 6.75 to 7.25).

In some embodiments, the starting dairy composition is skim milk, full-fat milk, semi-skim milk, cream, skim milk powder, whey powder, water, whey protein concentrate, milk protein concentrate, or a combination thereof.

For example, in order for a dairy composition to qualify as a milk, or dairy product under certain government or industry regulations, the dairy composition can be required to have a certain wt. % of milk solids, non-fat or other listed components.

In some embodiments, the dairy product comprises the sweetened dairy composition and at least one additional ingredient, for example, added sweetener, added non-nutritive sweetener having 0.08 or less kilocalories per gram, a zero-calorie sweetener, an added nutritive sweetener, added sugar, added sucrose, cocoa, a preparation or concentrate derived from fruit, an added flavor, an added color, an added stabilizer or texturizer or a combination thereof, thereby providing a flavored dairy product. For example, a preparation derived from fruit can be a fruit puree or concentrate.

In some embodiments, the dairy product comprises a sweetened dairy composition with no more than about 7.0, 5.0, 3.5, 1.0, 0.5, 0.1, or 0.001 wt. % of an added sweetener (e.g., an added nutritive sweetener, an added non-nutritive sweetener, an added sugar, steviol glycosides, xylitol, or a combination thereof). In some embodiments, the dairy product comprises no added sweetener. In some embodiments, the sweetened dairy product has no more than a weight percentage of sweetener that has a sweetness equivalent to 7.0, 5.0, 3.5, 1.0, 0.5, 0.1, 0.01, or 0.001 wt. % of sucrose in a sucrose-and-water solution that consists of sucrose and water. With respect to determining the equivalent sweetness of the mass of sweetener, the mass of sweetener id placed in a sweetener-and-water solution that consists of the sweetener and water and compared to the sucrose-and-water solution, for example, using a taste panel as described herein. In some embodiments, the sweetened dairy composition, which is a made from a starting dairy composition, comprises a sweetness equivalent to the sweetness of a sweetened starting dairy composition, which consists of the starting dairy composition (or equivalent composition) and sucrose, for example, so that the sucrose is present at 0.25 to 2 wt. %, 0.25 to 1.5 wt. %, 0.25 to 1.0 wt. %, or 0.25 to 0.75 wt. % of the sweetened starting dairy composition. The comparison of the sweetness of the sweetened dairy composition and the sweetened starting dairy composition can be made, for example, using a taste panel as described herein.

In some embodiments, the dairy product is provided at an ambient temperature or 0° C. to ambient temperature. In some embodiments, a dairy product (e.g., smoothie, milk) comprising a sweetened dairy composition is provided at a chilled temperature, for example, below ambient conditions or at a temperature of 0 to 10° C. or 0 to 4° C. In some embodiments the dairy product can be provided in liquid form at any temperature above a freezing temperature of the product and up to 4° C. or 10° C. In some embodiments the dairy product comprises an end-user package that contains the sweetened dairy composition.

As a person having ordinary skill in the art would understand upon reading the present disclosure, a selection of the various elements described for the sweetened dairy combination can be combined to create further embodiments, which are also considered to be disclosed

### Comparative Examples of Dairy Products Comprising a Sweetened Dairy Composition

### EXAMPLE 1

### Processing a 1 wt. % Fat Milk to Provide a Sweetened Dairy Composition

A starting dairy composition comprising 1 wt. % fat milk is provided with a nutritional composition summarized in Table 1 according to step 0102 of FIG. 1.

TABLE 1
Starting Dairy Composition (1 wt. % Fat Milk)

| Component | Amount | |
|---|---|---|
| Energy | 43 kcal per 100 g of the starting dairy | |
| | composition | |
| Protein | 3.5 | wt. % |
| Fat | 1.0 | wt. % |
| Carbohydrate | | |
| Lactose | 5.0 | wt. % |
| Glucose | 0 | wt. % |
| Galactose | 0 | wt. % |
| MSNF | 9.3 | wt. % |

The starting dairy composition is processed using a method in accordance with FIG. 1 and the following details. The provided starting dairy composition is stored at a hydrolysis temperature range equal to about 5° C. (can be 4 to 6° C.) and a yeast beta-D-galactosidase enzyme (in particular, a lactase enzyme) is then added to the starting dairy composition at a dosage so that the combined composition including lactase comprises 0.01 to 1.0 wt. % lactase-containing composition (can be 0.01 to 1.0 wt. %, 0.01 to 0.15 wt. %, or 0.02 to 0.08 wt. % lactase-containing composition). In some embodiments, the combined composition (e.g. the hydrolysis reagent composition) comprises at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition and optionally up to 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition.

In some embodiments, the lactase-containing composition comprises 1 to 10 wt. % lactase. In some embodiments, the lactase-containing composition comprises at least 1, 2, 3, 4, 5, 6, 7, 8 or 9 wt. % lactase and optionally up to 10, 9, 8, 7, 6, 5, 4, 3 or 2 wt. % lactase.

In some embodiments, the combined composition (e.g., the hydrolysis reagent composition) comprises at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase and optionally up to 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase.

In some embodiments, the lactase-containing composition has an activity equal to 2,500 to 65,000 enzyme units per milliliter of the lactase-containing composition (U/mL) at 25° C., equivalent to 41,675 to 1,083,550 nanokatal per milliliter of the lactase-containing composition (nkat/mL) at 25° C. For example, 1U is approximately equivalent to 16.67 nkatal. In some embodiments the lactase-containing composition has an activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/mL at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/mL at 25° C.; or a combination thereof (an activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/mL at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/mL at 25° C.; or a combination thereof). In some embodiments, the density of the lactase-containing composition can be approximately 1.0 g/mL. In some embodiments, the lactase-containing composition has an activity equal to 2,500 to 65,000 enzyme units per gram of the lactase-containing composition (U/g) at 25° C., equivalent to 41,675 to 1,083,550 nanokatal per gram of the lactase-containing composition (nkat/g) at 25° C. In some embodiments the lactase-containing composition has an activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/g at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/g at 25° C.; or a combination thereof (an activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/g at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/g at 25° C.; or a combination thereof).

In some embodiments, the lactase-containing composition has an activity equal to 2500 to 65,000 Lactase Units per gram of the lactase-containing composition, where one lactase unit is the quantity of enzyme that catalyzes hydrolysis to liberate 1 μmol/minute of o-nitrophenol from an o-nitrophenyl-β-D-galactopyranoside substrate at a pH of 4.5 and at a temperature equal to at least 28, 29, 30, 31, 32, 33, 34, 35, 36, 37, 38, 39, 40, 41, 42, or 43° C. and no more than 43, 42, 41, 40, 39, 38, 37, 36, 35, 34, 33, 32, 31, 30, 29, or 28° C., for example, at 37° C.

The lactase is a beta-D-galactosidase.

The lactase is allowed to hydrolyze the lactose in the starting dairy composition over a hydrolysis reaction time equal to 1 to 14 hours. In some embodiments, the lactase is allowed to hydrolyze the lactose in the starting dairy composition over a hydrolysis reaction time equal to at least 1, 2, 3, 4, 5, 6, 7, 8, 9, 10, 11, 12, or 13 hours, no more than 14, 13, 12, 11, 10, 9, 8, 7, 6, 5, 4, 3 or 2 hours, or a combination thereof.

The hydrolysis reaction time is selected in order to convert 60 wt. % (can be 40 to 65 wt. % or 50 to 77 wt. %) of the lactose to glucose and galactose. The hydrolyzed, sweetened dairy composition is pasteurized to deactivate the lactase-catalyzed hydrolysis reaction by heating the dairy composition to 90° C. (can be (i) at least 60, 61, 62, 63, 64, 65, 66, 67, 68, 69, 70, 71, 72, 73, 74, 75, 76, 77, 78, 79, 80, 81, 82, 83, 84, 85, 86, 87, or 88° C., (ii) no more than 105, 100, 95, 90, 89, 88, 87, 86, 85, 84, 83, 82, 81, 80, 79, 78, 77, 76, 75, 74, 73, 72, 71, 70, 69, 68, 67, 66, 65, 64, or 63° C., or (iii) a combination thereof) for 30 seconds (can be (i) at least 0.5, 1, 2, 3, 4, 5, 6, 7, 8, 9, 10, 20, 25, 30, 35, 40 or 60 seconds, (ii) at least 1, 2, 3, 4, 5, 6, 7, 8, 9, 10, 15, 20, 25, or 30 minutes, (iii) no more than 35, 30, 25, 20, 15, 10, 9, 8, 7, 6, 5, 4, 3, 2 or 1 minutes, (iv) no more than 60, 55, 50, 45, 40, 35, 30, 25, 20, 15, 10, 9, 8, 7, 6, 5, 4, 3, 2, 1.5 or 1 seconds, (v) for 25 to 35 minutes, for 20-40 or 25-35 seconds, or for 0.5 to 1.5 seconds, or (vi) a combination thereof), thereby providing the sweetened dairy composition with the desired lactose percent conversion. The nutritional composition of the resultant sweetened dairy composition is outlined in Table 2 below.

TABLE 2
Sweetened Dairy Composition

| Component | Amount |
|---|---|
| Energy | 43 kcal per 100 g of the sweetened dairy |
| | composition |
| Protein | 3.5 wt. % |
| Fat | 1.0 wt. % |
| Carbohydrate (Lactose) | |
| Lactose | 1.1 wt. % |
| Glucose | 2.1 wt. % |
| Galactose | 1.8 wt. % |
| MSNF | 9.3 wt. % |

The organoleptic properties of various dairy products, including the sweetened dairy composition shown in Table 2, which corresponds to dairy product T1, were described by a taste panel, and the results were analyzed using Quantitative Descriptive Analysis (QDA)®, Analysis of Variance (ANOVA) and Principle Components Analysis (PCA). The results helped the inventors more precisely and methodically understand how various organoleptic properties, including sweetness, are affected when a starting dairy composition (namely, T0, which is a reconstituted powdered milk equivalent to milk with 1 wt. % milk fat or 1% fat liquid milk) is modified by either (i) lactose-hydrolysis catalyzed by a first lactase enzyme (for example, to provide dairy product T1) or (ii) lactose-hydrolysis catalyzed by a second lactase enzyme, (for example, to provide dairy product T2) or (iii) lactose-hydrolysis catalyzed by a third lactase enzyme, (for example, to provide dairy product T3) (iv) adding sucrose to the starting dairy composition to provide a dairy product with 0.5 wt. % sucrose, and (v) adding sucrose to the starting dairy composition to provide a dairy product with 1 wt. % sucrose. The first, the second, and the third lactase enzymes were all provided by commercially available lactase-containing compositions.

Examples of commercially available lactase enzymes are described, for example, by Zolnere, K. and Ciprovica, I., “The Comparison of Commercially Available β-galactosidases for Dairy Industry: Review,” Research for Rural Development 2017, vol. 1, 215-222 (2017), D01:10.22616/rrd.23.2017.032, which is hereby incorporated by reference in its entirety as an example.

Each of the dairy products tasted by the taste panel are listed in Table 2.1. As a result of the experiments, the inventors were able to confirm that the techniques described herein can be utilized with several commercially available lactase-containing compositions. The inventors also envision that methods described herein can use any commercially available lactase enzyme, a lactase-containing composition described herein, or a combination thereof. Although, it can be advantageous to use a lactase-containing composition that has essentially no side activity. An example of a lactase-containing composition with essentially no side activity would be a lactase-containing composition whose total side activity is no more 0.2, 0.1, 0.09, 0.08, 0.07, 0.06, 0.05, 0.04, 0.03, 0.02, 0.01, 0.001, 0.0001, 0.00001, 0.000001, or 0.0000001 times, and optionally down to 0 times, the enzyme activity for lactase-catalyzed hydrolysis of lactose, where the total side activity is the sum of all enzyme activities for any enzymes in the lactase-containing composition that catalyze a reaction that is not lactose hydrolysis, and where both the enzyme activity and side activity are measured at 25° C., and at a pH value and lactose concentration that provides the maximum lactose hydrolysis rate for the lactase in the lactase-containing composition.

TABLE 2.1
Dairy Product Samples Tested for Organoleptic Properties

| Dairy | |
|---|---|
| Product | Description |
| T0 | Starting Dairy Composition (milk having 1 wt. % milk |
| | fat and reconstituted by adding water and cream to |
| | powdered skim milk) |
| T1 | Starting Dairy Composition subjected to lactose- |
| | hydrolysis catalyzed by enzyme 1 |
| T2 | Starting Dairy Composition subjected to lactose- |
| | hydrolysis catalyzed by enzyme 2 |
| T3 | Starting Dairy Composition subjected to lactose- |
| | hydrolysis catalyzed by enzyme 3 |
| S0.5 | Dairy Product consisting of 0.5 wt. % sucrose and |
| | 99.5 wt. % Starting Dairy Composition |
| S1 | Dairy Product consisting of 1 wt. % sucrose and 99 |
| | wt. % Starting Dairy Composition |

The organoleptic properties of each sample dairy product were measured using a taste panel with 9 to 11 trained panelists who were presented with the sample dairy products of Table 2.1 in random order. Each sample dairy product was tested in duplicate by each panelist. Each panelist rated 22 organoleptic attributes of each sample on a scale from 0 to 10, with 0 indicating that the attribute was not present and 10 indicating that the attribute was intensely sensed. The average ratings for each attribute across all panelists and all samples in duplicate were used to analyze statistical significance of differences in attributes from one product to another. Many of the measured attributes did not show statistically different results for one of the sweetened dairy compositions T1, T2 or T3 relative to the other products.

However, the results of the experiment did confirm that lactose-hydrolysis of dairy products can be used to increase the perceived sweetness of the dairy products. For example, dairy products T1, T2 and T3 were all sweeter than the starting dairy composition (namely, reconstituted 1% milk), approximately as sweet as dairy product S0.5, and less sweet than S1, taking into account the statistical significance of the data.

Accordingly, the sweetened dairy composition described herein can be provided with a perceived sweetness greater than the sweetness of the starting dairy composition. Furthermore, in some embodiments, in order for a sweetened starting dairy composition (i.e., composition consisting of the starting dairy composition and sugar) to have the same perceived sweetness as the sweetened dairy composition, sucrose must be added to the starting dairy composition until the sucrose makes up 0.5 wt. % (can be at least 0.25, 0.3, 0.35, 0.4, 0.45 or 0.5 wt. % (or ° Brix); no more than 0.75, 0.7, 0.65, 0.6, 0.55, or 0.5 wt. % (or ° Brix); or a combination thereof) of the sweetened starting dairy composition.

FIG. 3 is a graph illustrating the effects of lactose conversion upon overall sensorial experience. In particular, FIG. 3 shows the mass concentration of lactose, glucose, and galactose in grams per 100 mL of a starting dairy composition over 20 hours. FIG. 3 also shows how the overall sensorial experience of the dairy composition changes with the conversion of lactose to glucose and galactose during lactase-catalyzed hydrolysis of the lactose in the starting dairy composition. Furthermore, FIG. 3 shows an optimum (e.g., maximum desirability for at least some consumers or a taste panel) in overall sensorial experience being reached after approximately 65 wt. % of the initial lactose has been converted to glucose and galactose.

TABLE 2.2
Tabulated Form of the Data Illustrated in FIG. 3

| | | | | Overall |
|---|---|---|---|---|
| | | | | Sensorial |
| | Lactose | Glucose | Galactose | Experience |
| Time (hr) | (g/100 mL) | (g/100 mL) | (g/100 mL) | (Unitless) |
| 0 | 5.32 | 0 | 0.05 | 0 |
| 2 | 2.15 | 2 | 1.29 | 2 |
| 4 | 1.85 | 2.11 | 1.4 | 5 |
| 6 | 1.48 | 2.33 | 1.58 | 4 |
| 10 | 0.9 | 2.61 | 1.87 | 3 |
| 15 | 0.64 | 2.75 | 2.03 | 2 |
| 19 | 0.46 | 2.8 | 2.11 | 1 |

TABLE 2.3
Sensorial Experience Key for Table 2.2

| | |
|---|---|
| 0 | Sweetness of starting dairy composition at 0 hours |
| 2 | relatively lower increased sweetness at 2 hours |
| 5 | Optimal sweetness (i.e., peak sweetness) at 4 hours |
| 4 | Post optimal sweetness with relatively lower astringency |
| | at 6 hours |
| 3 | Relatively moderate astringency at 10 hours |
| 2 | Relatively strong astringency at 15 hours |
| 1 | Strongest astringency at 19 hours |

In the example of FIG. 3, the lactase enzyme is used at a dose so that in a hydrolysis reagent composition comprising the starting dairy composition and the enzyme, the enzyme-containing composition (e.g., lactase) makes up 0.04 to 0.08 wt. % (can be at least 0.04, 0.05, 0.06, or 0.07 wt. %; no more than 0.08, 0.07, 0.06, 0.05, or 0.04 wt. %; or a combination thereof) of the hydrolysis reagent composition. In other words, the ratio of the enzyme-containing composition (e.g., lactase) to the starting dairy composition was approximately 0.04 to 0.1 wt. % enzyme-containing composition (e.g., enzyme) to 99.08 to 99.02 wt. % starting dairy composition. Although not shown in FIG. 3, Table 2.2 and Table 2.3, additional experiments were conducted with lactase enzyme at concentrations within the range of 0.02 to 0.08 wt. %.

### EXAMPLE 2

### Dairy Product Comprising a Sweetened Dairy Composition

The sweetened dairy composition produced in Example 1 can be used to produce a dairy product (e.g., product formulation) described in Table 3 below. For example, the sweetened dairy composition can provide 95.91 wt. % of the dairy product (can range from 95.815 to 95.91 wt. % of the dairy product) and the sweetened dairy composition is blended with additional ingredients comprising sugar, cocoa, natural flavors and a texturizer to provide the remainder of the dairy product.

TABLE 3
Composition of a Dairy Product Comprising
a Sweetened Dairy Composition and Additional Ingredients

| Component | % w/w |
|---|---|
| Sweetened Dairy Composition | 95.91 |
| Sugar | 3 |
| Cocoa | 1 |
| Natural Flavors | 0.06 |
| Texturizers and Stabilizers | 0.03 |

In order to make a dairy product corresponding to the dairy product illustrated in Table 3, the following protocol can be used. First, the sweetened dairy composition from Example 1 is heated to 40° C. (can range from 40 to 60° C. or 40 to 50° C.), then dry ingredients comprising sugar, cocoa, at least one natural flavor and at least one texturizer (which can also be a stabilizer and/or a thickening agent) and/or at least one stabilizer (which can also be a texturizer) are added. The texturizers and/or stabilizers used, in the example or in general, can include Carrageenan and Gellan gum. The mixture is allowed to hydrate for 60 minutes (can range from 30 to 60 minutes). Then, the mixture is heated to 65° C. (can range from 65 to 70° C.) before being processed by 2-stage homogenization (150/50 bar gauge). The first stage of the homogenization process is conducted at a pressure of about 150 bar gauge. The second stage of homogenization is conducted at a pressure of about 50 bar gauge. The 2-stage homogenization is followed by 2-stage ultra-high temperature (UHT) processing. The first stage of UHT processing comprises heating the sweetened dairy formulation to 90 ° C. for about 15 seconds. This is followed by the second stage of UHT processing in which the sweetened dairy formulation is heated to about 138° C. for about 4 seconds (can range from 4 to 5 seconds). The resultant aseptic, product formulation comprising the sweetened dairy composition is in the form of a beverage. The dairy product is then cooled to 20° C. (can range from 20 to 25° C.) and can be packaged into aseptic containers.

### EXAMPLE 3

### Acidified Dairy Product Comprising a Sweetened Dairy Composition

The sweetened dairy composition produced in Example 1 is used to produce a dairy product described in Table 4 below. The sweetened dairy composition provides 90.84 wt. % of the dairy product and the sweetened dairy composition is blended with additional ingredients including a thickening agent or texturizer (e.g., the thickening agent or texturizer can be carboxymethylcellulose (CMC)), guar gum, sugar, fruit concentrate or preparation, citric acid, lactic acid, and natural flavors to provide the remainder of the dairy product.

TABLE 4
Acidified Dairy Product Ingredients

| Component | % w/w |
|---|---|
| Sweetened Dairy Composition | 93.84 |
| CMC | 0.45 |
| Guar Gum | 0.05 |
| Sugar | 3 |
| Fruit Concentrate or Preparation | 2 |
| Citric acid | 0.35 |
| Lactic acid | 0.25 |
| Natural Flavors | 0.06 |

The sweetened dairy composition produced in Example 1 is heated to about 45° C. (can range from 45 to 55° C.). Dry ingredients including stabilizers (e.g., CMC, Guar Gum), sugar, fruit concentrate or preparation, and natural flavors were added. The mixture was allowed to hydrate for about 45 minutes (can be 30 to 60 minutes). Then food grade acids, for example, citric acid, lactic acid, or ascorbic acid are added to the mixture. The resulting dairy product (e.g., beverage) is subsequently heated to about 65 ° C. (can be 65 to 70° C.). Heating is followed by processing the combination using 2-stage homogenization (180/20 bar gauge). The first stage of the homogenization process is conducted at a pressure of about 180 bar gauge. The second stage of homogenization is conducted at a pressure of about 20 bar gauge. The 2-stage homogenization is followed by 2 stage UHT heat processing. The first stage of UHT heat processing comprises heating the dairy product, to 80° C. (can be 80 to 85° C.) for 15 seconds. Next, the second stage of UHT heat processing comprises heating the dairy product to 105° C. for 30 seconds. The resultant aseptic, sweetened, acidified dairy beverage formulation is cooled to 20° C. (can be 20 to 25° C.) and packaged into aseptic or clean fill containers.

### Dairy Product Comprising a Fermented Sweetened Dairy Composition

Moreover, in some embodiments, the dairy products (e.g., sweetened dairy compositions or product formulations) described herein can be or can be used to produce a fermented dairy product, for example, a fermented sweetened dairy composition. As an example, the fermented, sweetened dairy composition can be a yogurt (e.g., flavored yogurt, drinkable yogurt, spoonable yogurt, squeezable yogurt, yogurt packaged in a cup, yogurt packaged in a bowl, yogurt packaged in a pouch, or a combination thereof).

The fermented sweetened dairy composition can be provided by subjecting the starting dairy composition to a co-reaction. As a skilled person would understand, the co-reaction involves both hydrolysis and fermentation occurring at the same time to form the sweetened dairy composition. In some embodiments, the hydrolysis and fermentation overlap for at least 10, 20, 30, 40, 50, 60, 70, 80, 90, 95, 96, 97, 98, 99 or 100% of the duration of the fermentation step.

During the co-reaction involving hydrolysis and fermentation, the hydrolysis and fermentation reactions can be controlled on a competitive basis. In other words, because both lactose hydrolysis and lactic acid fermentation use lactose as a reagent, as both reactions convert lactose into their respective products, the lactose available for the competing reaction will decrease. For example, in the process used to make a fermented sweetened dairy composition, the hydrolysis reaction can be taken to completion or near completion resulting in a total or nearly total depletion of substrate (lactose).

Surprisingly, an embodiment of the fermented, sweetened dairy composition was palatable when subjected to total or near-total conversion of lactose to lactic acid (via fermentation) or glucose and galactose (via lactase-catalyzed hydrolysis) while avoiding astringency. By comparison, for the non-fermented sweetened dairy composition, lactose hydrolysis was deactivated well before complete conversion to obtain desirable product characteristics including the avoidance of astringency. Without being bound by theory, it is believed that the products of lactic acid fermentation, including additional aroma, perhaps in combination with fat, help to mask undesirable organoleptic properties (e.g. tastes and textures) that might otherwise be apparent. Additionally, the co-fermentation of lactose can result in a faster conversion of lactose to non-lactose products than either lactic acid fermentation or lactose hydrolysis alone. Additionally, it can decrease production time relative to an embodiment that first hydrolyzes a portion of the lactose and then conducts a fermentation reaction on a composition comprising the hydrolyzed lactose and remaining unhydrolyzed lactose.

As a person having ordinary skill in the art would understand upon reading the present disclosure, a dairy product (e.g., sweetened dairy composition or fermented sweetened dairy composition) produced by enhancing the sweetness of a starting dairy composition without adding sweeteners can provide many advantages, including those previously discussed with reference to a sweetened dairy composition in general.

Similarly, the features, characteristics (e.g., composition of starting materials, composition of additional ingredients, or physical properties), conditions (e.g., storage, process conditions), and options, previously described as applicable to the sweetened dairy composition, a dairy product (e.g., product formulation) comprising the sweetened dairy composition, or a starting dairy composition used to make the sweetened dairy composition are also applicable to the fermented sweetened dairy composition, a dairy product (e.g., formulated dairy product) comprising the fermented sweetened dairy composition, or a starting dairy composition used to make the fermented sweetened dairy composition. Furthermore, some additional or alternative features, characteristics, conditions, and options applicable to the fermented sweetened dairy composition are also described herein.

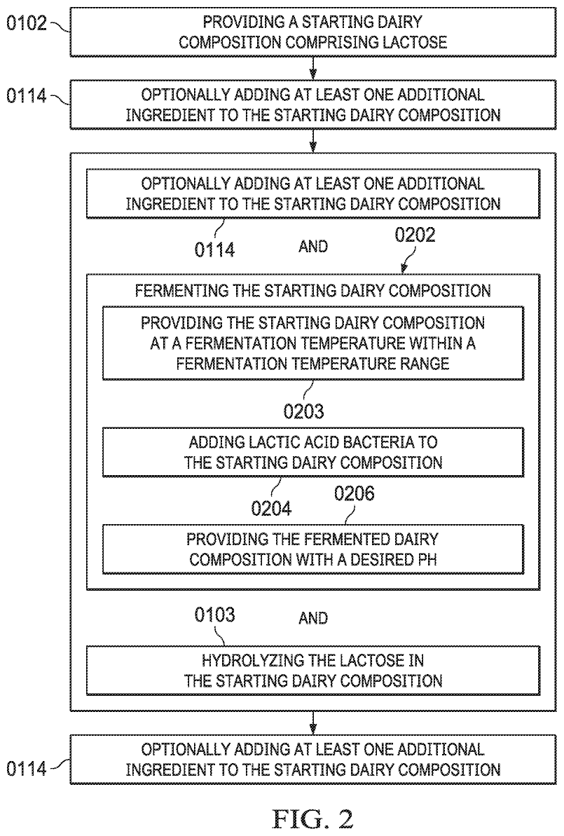

With reference now to FIG. 2, an embodiment of a method for increasing a sweetness of a starting dairy composition will now be described. As illustrated, the method provides a dairy product comprising a sweetened dairy composition, which is fermented.

A first step comprises providing 0102 the starting dairy composition (N/A) (e.g., milk) comprising lactose.

An optional second step comprises adding 0114 at least one additional ingredient to the starting dairy composition.

A third step comprises fermenting 0202 the starting dairy composition (e.g., fermenting at least a portion of the lactose in the starting dairy composition to lactic acid) to provide a fermented dairy composition. If the fermentation step occurs in conjunction with or after the hydrolyzing step 0103, the fermentation step can result in a fermented sweetened dairy composition.

A fourth step comprises hydrolyzing 0103 the lactose in the starting dairy composition, for example, to provide a fermented sweetened dairy composition. The fermentation 0202 can occur as a co-reaction with the step of hydrolyzing 0103 the lactose. Accordingly, the fermentation 0202 and/or hydrolyzing step can occur before, adding 0114 at least one additional ingredient, or a combination thereof.

A fifth step can comprise allowing the lactase-catalyzed hydrolysis reaction, fermentation reaction, or combination thereof to run to completion or substantially to completion (e.g., 80, 81, 82, 83, 84, 85, 90, 95, 96, 97, 98 or 99 wt. % and up to 100 wt. % completion), thereby providing the sweetened dairy composition with a lactose percent conversion equal to 80 to 100 wt. %. In some embodiments, the lactase is allowed to hydrolyze the lactose in the starting dairy composition over a hydrolysis reaction time (or hydrolysis and fermentation co-reaction time) equal to 1 to 14 hours. In some embodiments, the lactase is allowed to hydrolyze the lactose in the starting dairy composition over a hydrolysis reaction time equal to at least 1, 2, 3, 4, 5, 6, 7, 8, 9, 10, 11, 12, or 13 hours, no more than 14, 13, 12, 11, 10, 9, 8, 7, 6, 5, 4, 3 or 2 hours, or a combination thereof. The hydrolysis reaction time (or co-reaction time) is selected in order to convert a desired amount of the lactose in the starting dairy composition (e.g., 80, 81, 82, 83, 84, 85, 90, 95, 96, 97, 98 or 99 wt. % and up to 100 wt. %) to glucose, galactose (e.g., via hydrolysis) and lactic acid (e.g., via fermentation).

As can be seen, with reference to the present disclosure, the rate of lactose hydrolysis achieved can be controlled using factors including the mole concentration of lactose in a hydrolysis reagent composition (which is affected by the competing use of lactose in the lactose fermentation reaction), the mole concentration of lactase in a hydrolysis reagent composition, the enzyme activity of the lactase-containing composition used to provide the lactase, the mole concentration of lactose hydrolysis products in the hydrolysis reagent composition, the temperature of the hydrolysis reagent composition, and the pH of the hydrolysis reagent composition. Furthermore, the ultimate percent conversion of lactose hydrolysis reaction in a hydrolysis reagent composition can be controlled by changing the rate of lactose hydrolysis or changing the time that the hydrolysis reagent composition is subject to the rate of lactose hydrolysis. In some embodiments, it can be desirable to provide a lactose hydrolysis reaction rate that is configured (e.g., purposefully faster or slower) to match daily or weekly production schedules.

Additionally, the rate of lactose fermentation achieved can be controlled using factors including the mole concentration of lactose in a reagent composition (which is affected by the competing use of lactose in the lactose hydrolysis reaction), the mole concentration of a culture-containing composition in a reagent composition, the activity of the culture-containing composition, the mole concentration of lactose fermentation products in the reagent composition, the temperature of the reagent composition, and the pH of the reagent composition. Furthermore, the ultimate percent conversion of lactose fermentation reaction in a reagent composition can be controlled by changing the rate of lactose fermentation or changing the time that the reagent composition is subject to the rate of lactose fermentation. In some embodiments, it can be desirable to provide a lactose fermentation reaction rate that is configured (e.g., purposefully faster or slower) to match daily or weekly production schedules. Additionally, in some embodiments, it can be desirable to provide a lactose fermentation reaction rate and/or lactose hydrolysis fermentation rate that are configured (e.g., purposefully faster or slower) to achieve desirable final product specifications (e.g., pH, percent lactose conversion, desirable organoleptic properties, or a combination thereof).

An optional sixth step comprises adding 0114 at least one additional ingredient to the sweetened dairy composition.

In some embodiments, adding 0114 the at least one additional ingredient to the starting dairy composition can occur before, during or after fermenting 0202 the starting dairy composition, or hydrolyzing 0103 the lactose in the starting dairy composition. As examples, the at least one additional ingredient can be selected from one or more of the following: any ingredient described elsewhere in this application, yogurt stabilizers, skim milk powder, whey powder, and milk proteins.

In some embodiments, the step of fermenting 0202 the starting dairy composition comprises subsidiary steps. A first subsidiary step comprises providing 0203 the starting dairy composition at a fermentation temperature within a fermentation temperature range equal to 28 to 43° C. A second subsidiary step comprises adding 0204 lactic acid bacteria (e.g., Lactobacillus delbrueckii subsp. Bulgaricus, Streptococcus thermophilus) to the starting dairy composition to produce lactic acid from the lactose in the starting dairy composition. A third subsidiary step comprises providing 0206 the fermented dairy composition (e.g., fermented sweetened dairy composition) with a desired pH.

In some embodiments of the fermenting step 0202, the fermentation reaction can continue for a time sufficient to provide 0206 the fermented dairy composition (e.g., fermented sweetened dairy composition) with a desired pH, for example, no more than 4.6, 4.5, 4.4, 4.3, or 4.2; no less than 4.1 or 4.2; or a combination thereof. Additionally, the step of adding 0204 lactic acid bacteria can occur after providing the starting dairy composition within a fermentation temperature range. In some embodiments, the fermentation of lactose in the starting dairy composition is allowed to occur over a fermentation reaction time equal to at least 1, 2, 3, 4, 5, 6, 7, 8, 9, 10, 11, 12, or 13 hours, no more than 14, 13, 12, 11, 10, 9, 8, 7, 6, 5, 4, 3 or 2 hours, or a combination thereof. It should be understood that the hydrolysis reaction time and fermentation reaction time can be equivalent or substantially equivalent, especially when the reactions occur as co-reactions.

In some embodiments, the step of hydrolyzing 0103 the lactose in the starting dairy composition comprises several subsidiary steps. A first subsidiary step comprises adding lactase to the starting dairy composition to provide a hydrolysis reagent composition comprising the starting dairy composition and the lactase. Commercially available lactase enzymes that are active in a neutral to low pH environment (e.g., from a pH of about 7.0 down to about 4.1) are useful for making the sweetened dairy composition. As an example, the lactase can be a standardized liquid wide spectrum β-galactosidase (lactase) from Bifidobacterium bifidum. In selecting a lactase enzyme for use in the processes of the present disclosure, it can be preferable to avoid lactase enzymes with side activity (e.g. activity catalyzing reactions other than the hydrolysis of lactose), which can be caused by enzymes other than lactase. An example of a lactase-containing composition with essentially no side activity would be a lactase-containing composition whose total side activity is no more 0.2, 0.1, 0.09, 0.08, 0.07, 0.06, 0.05, 0.04, 0.03, 0.02, 0.01, 0.001, 0.0001, 0.00001, 0.000001, or 0.0000001 times, and optionally down to 0 times, the enzyme activity for lactase-catalyzed hydrolysis of lactose, where the total side activity is the sum of all enzyme activities for any enzymes in the lactase-containing composition that catalyze a reaction that is not lactose hydrolysis, and where both the enzyme activity and side activity are measured at 25° C., and at a pH value and lactose concentration that provides the maximum lactose hydrolysis rate for the lactase in the lactase-containing composition. In some embodiments the hydrolysis reagent composition comprises 0.01 to 1.0 wt. % lactase-containing composition or 0.01 to 0.15 wt. % lactase-containing composition. In some embodiments, the hydrolysis reagent composition comprises at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition and optionally up to 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition.

In some embodiments, the lactase-containing composition comprises 1 to 10 wt. % lactase. In some embodiments, the lactase-containing composition comprises at least 1, 2, 3, 4, 5, 6, 7, 8 or 9 wt. % lactase and optionally up to 10, 9, 8, 7, 6, 5, 4, 3 or 2 wt. % lactase.

In some embodiments, the hydrolysis reagent composition comprises at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase and optionally up to 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase.

In some embodiments, it can be preferable to provide the hydrolysis reagent composition with a desired enzyme activity so that the lactase in the hydrolysis reagent hydrolyzes lactose at a desired rate in terms of moles per unit time. In some embodiments, the lactase-containing composition has an activity equal to 2,000 to 5,500 enzyme units per milliliter of the lactase-containing composition (U/mL) at 25° C., equivalent to 33,340 to 91,685 nanokatal per milliliter of the lactase-containing composition (nkatal/mL) at 25° C. 1 U is approximately equivalent to 16.67 nkatal. In some embodiments the lactase-containing composition has an activity equal to at least 2,000, 3,000, 4,000, or 5,000 U/mL at 25° C.; no more than 5,500, 5,000, 4,000, or 3,000 U/mL at 25° C.; or a combination thereof (an activity equal to at least 33,340, 50,010, 66,680, or 83,350 nkat/mL at 25° C.; no more than 91,685, 83,350, 66,680, or 50,010 nkat/mL at 25° C.; or a combination thereof). In some embodiments, the density of the lactase-containing composition can be approximately 1.0 g/mL. In some embodiments, the lactase-containing composition has an activity equal to 2,000 to 5,500 enzyme units per gram of the lactase-containing composition (U/g) at 25° C., equivalent to 33,340 to 91,685 nanokatal per gram of the lactase-containing composition (nkat/g) at 25° C. In some embodiments the lactase-containing composition has an activity equal to at least 2,000, 3,000, 4,000, or 5,000 U/g at 25° C.; no more than 5,500, 5,000, 4,000, or 3,000 U/g at 25° C.; or a combination thereof (an activity equal to at least 33,340, 50,010, 66,680, or 83,350 nkat/g at 25° C.; no more than 91,685, 83,350, 66,680, or 50,010 nkat/g at 25° C.; or a combination thereof).

In some embodiments, the lactase-containing composition has an activity equal to 2000 to 5500 Lactase Units per gram of the lactase-containing composition, where one lactase unit is the quantity of enzyme that catalyzes hydrolysis to liberate 1 μmol/minute of o-nitrophenol from an o-nitrophenyl-β-D-galactopyranoside substrate at a pH of 4.5 and at a temperature equal to at least 28, 29, 30, 31, 32, 33, 34, 35, 36, 37, 38, 39, 40, 41, 42, or 43° C. and no more than 43, 42, 41, 40, 39, 38, 37, 36, 35, 34, 33, 32, 31, 30, 29, or 28° C., for example, at 37° C. The rate of hydrolysis can be measured using a spectrophotometer.

The lactase enzyme is a beta-D-galactosidase.

For example, the lactase enzyme can be purified or highly purified (e.g., in the sense of having less or essentially no undesirable side enzyme activity) and can be a standardized liquid wide spectrum Bifidobacterium bifidum β-galactosidase (lactase). In some embodiments, an enzyme composition comprises the enzyme and solvents, for example, glycerol and water. The enzymes can be produced by submerged fermentation on a vegetable substrate using a selected strain of bacteria kept under contained conditions and not present in the final product. The lactase enzyme hydrolyzes lactose into a mixture of glucose and galactose. Examples of commercially available lactase enzymes are described, for example, by Zolnere, K. and Ciprovica, I., “The Comparison of Commercially Available β-galactosidases for Dairy Industry: Review,” Research for Rural Development 2017, vol. 1, 215-222 (2017), DOI:10.22616/rrd.23.2017.032, which is hereby incorporated by reference in its entirety as an example.

The activity of the lactase enzyme in the lactase-containing composition can range from 2000 to 5500 Lactase Units per gram at temperatures from 28 to 43° C. One lactase unit is the quantity of enzyme that catalyzes hydrolysis to liberate 1 μmol/minute of o-nitrophenol from an o-nitrophenyl-β-D-galactopyranoside substrate at 37° C. and at a pH of 4.5. The rate of hydrolysis can be measured using a spectrophotometer. Although, if desired, the temperature at which the lactase unit is measured can be specified at a different temperature, for example, any temperature from 28 to 43° C. The effective dosage can be calculated from the mass and/or volume of the composition to be hydrolyzed, the mass and/or volume of the lactose in the composition to be hydrolyzed, the activity of the enzyme, the temperature of the composition to be hydrolyzed, the pH of the composition to be hydrolyzed, or a combination thereof. The lactase enzyme can be added directly to a starting dairy composition without dilution to provide a hydrolysis reagent composition. In some embodiments, the hydrolysis reagent composition comprises a lactase-containing composition that is added at a rate of 0.04 milliliters per 100 grams of the starting dairy composition. In some embodiments, the hydrolysis reagent composition comprises at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition and optionally up to 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition. In some embodiments, the lactase-containing composition comprises 1 to 10 wt. % lactase. In some embodiments, the lactase-containing composition comprises at least 1, 2, 3, 4, 5, 6, 7, 8 or 9 wt. % lactase and optionally up to 10, 9, 8, 7, 6, 5, 4, 3 or 2 wt. % lactase. In some embodiments, the hydrolysis reagent composition comprises at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase and optionally up to 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase. The lactase enzyme is a beta-D-galactosidase.

A second subsidiary step comprises providing the hydrolysis reagent composition at a hydrolysis temperature within a hydrolysis temperature range, for example, 28 to 43° C., although other temperatures can also be useful depending on the lactase enzyme used.

A third subsidiary step comprises maintaining the hydrolysis reagent composition within the hydrolysis temperature range for a hydrolysis reaction time, which is effective to provide the sweetened dairy composition with the desired lactose percent conversion (e.g., complete conversion or substantially complete conversion of lactose to glucose and galactose and/or lactic acid, for example, 80, 81, 82, 83, 84, 85, 90, 95, 96, 97, 98 or 99 wt. % conversion and up to 100 wt. % conversion).

In some embodiments, optionally adding 0114 at least one additional ingredient to the starting dairy composition occurs before or after, before and after, or after another step. For example, the other step can be maintaining the hydrolysis reagent composition within the hydrolysis temperature range for a hydrolysis reaction time. In some embodiments, adding lactase to the starting dairy composition can occur before, while, or both before and while maintaining the starting dairy composition or the hydrolysis reagent composition within the hydrolysis temperature range for a hydrolysis reaction time, within the fermentation temperature range for a fermentation reaction time, or a combination thereof. It is worthwhile to note that that the hydrolysis temperature range and the fermentation temperature can be the same or overlap. Similarly, the hydrolysis reaction time and the fermentation reaction time can be the same or overlap.

As an example, lactase can be added to the starting dairy composition after heating the starting dairy composition to the lactase hydrolysis reaction temperature and/or fermentation temperature range. This could be useful if the start of the lactose hydrolysis reaction is to be controlled by the addition of the enzyme. Under these circumstances, it can be desirable to first heat or cool the dairy composition to a desired reaction temperature so that the lactose hydrolysis reaction will begin immediately upon the addition of the lactase.

In some embodiments, the dairy product (e.g., the fermented sweetened dairy composition or dairy product comprising the fermented sweetened dairy composition) comprises a mass ratio of lactose:glucose:galactose equal to 0.01-1.0:1.0-2.4:1.0-2.7. In some embodiments, the dairy product comprises a mass ratio of lactose to glucose equal to 0.01:2.4 to 1.0:1.0. In some embodiments, the dairy product comprises a mass ratio of lactose to galactose equal to 0.01:2.7 to 1.0:1.0. In some embodiments, the dairy product comprises: 0.01 to 1.0 wt. % lactose, 1.0-2.4 wt. % glucose, and 1.0 to 2.7 wt. % galactose. In some embodiments, the dairy product (e.g., fermented sweetened dairy composition or dairy product comprising the fermented sweetened dairy composition) comprises 8.0-14% wt. % milk solids, non-fat, 0 to 5 wt. % fat, or a combination thereof. For example, in order for a dairy product to qualify as a milk, or dairy product under certain government or industry regulations, the dairy composition can be required to have a certain wt. % of milk solids, non-fat or other listed components.

In some embodiments, the sweetened dairy composition is a fermented sweetened dairy composition. For example, the fermented sweetened dairy composition can comprise yogurt cultures (e.g., live yogurt cultures). In addition, a dairy product can include the fermented sweetened dairy composition and additional ingredients, for example, flavors or any other additional ingredients described herein for a flavored dairy product or product formulation.

In some embodiments, yogurt cultures (e.g., live yogurt cultures) comprise specific strains of bacteria might be used for probiotic effect: for example, Lactobacillus acidophilus, L. reuteri, Bifido bacteria, probiotic species of Lactococcus lactis, or a combination thereof. These microorganisms can be used alone or in combination with other cultures, e.g., thermophilic, yogurt or mesophilic cultures.

In some embodiments, the dairy product comprises a fermented sweetened dairy composition with at least 0.001, 0.1, 0.2, 0.3, 0.4, 0.49 0.5, 1.0, 1.5, 2.0, 2.5 or 3.0 wt. % added sweetener (e.g., non-nutritive sweeteners, nutritive sweeteners, sugar, sucrose, fructose, glucose, xylitol, steviol glycosides, or a combination thereof), no more than about 7.0, 5.0, 3.5, 1.0, 0.5, 0.1, or 0.001 wt. % of an added sweetener, or a combination thereof.

In some embodiments, a dairy product comprising the fermented sweetened dairy composition is provided at an ambient temperature. In some embodiments, the fermented sweetened dairy composition (e.g., smoothie, milk, yogurt) is provided in a chilled condition, for example, below ambient temperature, or at a temperature of 0 to 10° C. or 0 to 4° C. It should be understood that when solutes are present in the fermented sweetened dairy composition and depress the freezing point of the composition below 0° C., then the product can be provided in liquid form at temperatures at or below 0° C. In some embodiments, the fermented sweetened dairy composition can be provided at any temperature above the freezing temperature of the product and up to a temperature of 4° C. or 10° C.

In some embodiments, the dairy product comprises a package for the fermented sweetened dairy composition with optional additional ingredients. In some embodiments, the package is an end-user package. In some embodiments, the package comprises a label, and optionally the label can comprise a brand name for the dairy product, a sell-by date, nutrition information for the dairy product, serving size for the dairy product, calories per serving of the dairy product, fat per serving of the dairy product, carbohydrates per serving of the dairy product, protein per serving of the dairy product, vitamins per serving of the dairy product, minerals per serving of the dairy product, a listing of ingredients in the dairy product, a listing of live cultures in the dairy product, or a combination thereof.

As a person having ordinary skill in the art would understand upon reading the present disclosure, a selection of the various elements described for the fermented, sweetened dairy combination can be combined to create further embodiments, which are also considered to be disclosed herein.

### Comparative Example Of Dairy Product Comprising A Fermented Sweetened Dairy Composition

### EXAMPLE 4

### Processing of 2.5 wt. % Fat Milk to a Sweetened Dairy Composition

A starting dairy composition comprising 2.5 wt. % fat milk is provided with a nutritional composition summarized in Table 5. The starting dairy composition is processed in accordance with FIG. 2.

TABLE 5
Starting Dairy Composition (2.5 wt. % Fat Milk)

| Component | Amount | |
|---|---|---|
| Energy | 55 kcal per 100 g of the Starting Dairy | |
| | Composition | |
| Protein | 3.1 | wt. % |
| Fat | 2.5 | wt. % |
| MSNF | 8.9 | wt. % |
| Carbohydrate | | |
| Lactose | 5.0 | wt. % |
| Glucose | 0 | wt. % |
| Galactose | 0 | wt. % |

The starting dairy composition summarized in Table 5 is preliminarily treated (i.e., clarified) before a yogurt heating process. The starting dairy composition is heated to a temperature equal to about 60° C. (can be 50 to 70° C.) and then homogenized, for example, the homogenization can occur in 2 stages at a first stage pressure equal to about 180 to 200 bar gauge and at a second stage pressure equal to about 20% (can be about 15-25%) of the first stage pressure or about 27 to 50 bar gauge. As can be seen, the first stage pressure for the 2-stage homogenization is higher than the second stage pressure. Alternatively, the homogenization can be conducted in one stage at a pressure maintained at about 150 bar gauge (can be 150 to 200 bar gauge). The homogenized dairy composition is then pasteurized, for example, at 90° C. (can be 90 to 95° C.) for 540 seconds (can be 240 to 540 seconds).

Next, the homogenized dairy composition is cooled to 38° C. (can be 38 to 42 ° C.) and provided in a fermentation tank. Then a starter culture is introduced into the homogenized dairy composition in the fermentation tank to ferment the homogenized dairy composition and to provide a fermented composition.

The starter culture is introduced into the fermentation tank via a top hatch or special transfer unit for the starter culture. An enzyme is introduced during the fermentation step together with the starter culture into the fermentation tank. As another option, the enzyme can be introduced to the homogenized dairy composition first, then the starter culture is introduced into the combined composition immediately (can be within 0 to 5 minutes or within 1 to 5 minutes) after the starter culture is introduced.

The starter culture is YF-L703 (Lactobacillus delbrueckii subsp. Bulgaricus, Streptococcus thermophilus) from Chr. Hansen, of Hoersholm, Denmark, which starter culture is a Direct Vat Set (DVS) type starter culture with an activity of 500 U (Streptococcus thermophilus and Lactobacillus delbruecki subsp. Bulgaricus) per package of the starter culture, with one package being added per 2500 liters (about 2575 kg) of the homogenized dairy composition (e.g., milk). The DVS type starter culture does not need to be dissolved in a vessel or cup before being added to the starting dairy composition in the fermentation tank. The starter culture is added to the starting dairy composition so that the resulting composition comprises an activity of 0.194 (can be about 100 to 300, or 150 to 250) U (Streptococcus thermophilus and Lactobacillus delbruecki subsp. Bulgaricus) per 1 kilogram of the dairy composition.

The enzyme is a lactase enzyme with little or essentially no undesirable side enzyme activity. The amount of the lactase-containing composition added to the dairy composition can provide a combined composition having about 0.01 wt. % (can be 0.01 to 0.15 wt. %) lactase. The activity of the lactase enzyme is 2000 Lactase Units per gram of the lactase enzyme at 28° C. (can range from 2000 lactase units per gram at 28 ° C. to 5500 lactase units per gram at 43° C.). The lactase enzyme-containing composition is added directly added to the dairy composition without dilution.

In some embodiments, the combined composition (e.g. the hydrolysis reagent composition) comprises at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition and optionally up to 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition.

In some embodiments, the lactase-containing composition comprises 1 to 10 wt. % lactase. In some embodiments, the lactase-containing composition comprises at least 1, 2, 3, 4, 5, 6, 7, 8 or 9 wt. % lactase and optionally up to 10, 9, 8, 7, 6, 5, 4, 3 or 2 wt. % lactase.

In some embodiments, the combined composition (e.g., the hydrolysis reagent composition) comprises at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase and optionally up to 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase.

In some embodiments, the lactase-containing composition has an activity equal to 2,000 to 5,500 enzyme units per milliliter of the lactase-containing composition (U/mL) at 25° C., equivalent to 33,340 to 91,685 nanokatal per milliliter of the lactase-containing composition (nkat/mL) at 25° C. 1 U is approximately equivalent to 16.67 nkatal. In some embodiments the lactase-containing composition has an activity equal to at least 2,000, 3,000, 4,000, 5,000 U/mL at 25° C.; no more than 5,500, 5,000, 4,000, or 3,000 U/mL at 25° C.; or a combination thereof (an activity equal to at least 33,340, 50,010, 66,680, or 83,350 nkat/mL at 25° C.; no more than 91,685, 83,350, 66,680, or 50,010 nkat/mL at 25° C.; or a combination thereof). In some embodiments, the density of the lactase-containing composition can be approximately 1.0 g/mL. In some embodiments, the lactase-containing composition has an activity equal to 2,000 to 5,500 enzyme units per gram of the lactase-containing composition (U/g) at 25° C., equivalent to 33,340 to 91,685 nanokatal per gram of the lactase-containing composition (nkat/g) at 25° C. In some embodiments the lactase-containing composition has an activity equal to at least 2,000, 3,000, 4,000, or 5,000 U/g at 25° C.; no more than 5,500 5,000, 4,000, or 3,000 U/g at 25° C.; or a combination thereof (an activity equal to at least 33,340, 50,010, 66,680, or 83,350 nkat/g at 25° C.; no more than 91,685, 83,350, 66,680, or 50,010 nkat/g at 25° C.; or a combination thereof).

The lactase enzyme is a beta-D-galactosidase.

The fermentation step continues until the fermented composition reaches a pH value of 4.6 (can be 4.1 to 4.6). At the end of fermentation process almost complete cleavage of lactose into glucose and galactose is observed in the resulting fermented sweetened dairy composition, which in this example, is a yogurt. The composition of the fermented sweetened dairy composition is summarized in Table 6.

The fermented sweetened dairy composition is further processed by a high-shear mixer, stretch-valve or dispersant and then cooled to 6° C. (can be 6 to 20° C.).

### EXAMPLE 4.1

### Sweetness Comparison

The fermented sweetened dairy composition made in accordance with Example 4 was compared to control yogurts made using the fermentation conditions of the fermented sweetened dairy composition, but without lactose hydrolysis. The fermented sweetened dairy composition was sweeter than a first control yogurt without sugar, sweeter than a second sweetened control yogurt comprising 1 wt. % sucrose, and less sweet than a third sweetened control yogurt comprising 2 wt. % sucrose. Accordingly, the fermented sweetened dairy composition had a sweetness equivalent to between 1 and 2 grams sucrose in 100 grams of a sweetened control yogurt, where the sweetened control yogurt consists of the control yogurt and the sucrose.

The processed fermented sweetened dairy composition can optionally be mixed or prepared with fruit preparations, grains (e.g., cereals, legumes, or a combination thereof), among other additional ingredients, to provide a product formulation.

### EXAMPLE 4.2

### Fruit Preparation

An example of a fruit preparation comprises: strawberry, sugar, water, modified starch, flavor, colorant and acidity regulator (e.g., sodium citrate).

The dairy product comprising the fermented sweetened dairy composition can be packaged into aseptic containers and kept at refrigerated temperatures.

TABLE 6
Fermented Sweetened Dairy Composition

| Component | Amount |
|---|---|
| Energy | 55 kcal per 100 g of fermented |
| | sweetened dairy composition |
| Protein | 3.1 wt. % |
| Fat | 2.5 wt. % |
| MSNF | 8.9 wt. % |
| Carbohydrate | |
| Lactose | <0.1 wt. % |
| Glucose | 2.4 wt. % |
| Galactose | 2.5 wt. % |

### Additional Embodiments

The following clauses are offered as further description of the disclosed invention:

1. A dairy product comprising a sweetened dairy composition, the sweetened dairy composition comprising:

lactose, glucose and galactose;

wherein the mass ratio of the lactose to the glucose in the sweetened dairy composition is from 1.0:2.7 to 2.6:1.5; and

wherein the mass ratio of the lactose to the galactose in the sweetened dairy composition is from 1.0:2.2 to 2.6:1.1; and

optionally wherein the sweetened dairy composition comprises:
at least 1.0, 1.5 or 2.0 wt. % lactose;
no more than 2.6, 2.0, or 1.5 wt. % lactose;
at least 1.5 or 2.0 wt. % glucose;
no more than 2.0 or 2.7 wt. % glucose;
at least 1.0, 1.1, 1.25, 1.5, or 1.75 wt. % galactose;
no more than 1.25, 1.5, 1.75, 2.0, 2.1 or 2.2 wt. % galactose;
or a combination thereof;

optionally wherein the sweetened dairy composition is made from a starting dairy composition, wherein the starting dairy composition comprises milk from one or more species of mammals, optionally wherein the milk is bovine milk, optionally, wherein the milk is pasteurized milk, whole milk, reduced-fat milk, milk having nominally 3.5 wt. % milk fat, milk having nominally 2 wt. % milk fat, milk having nominally 1 wt. % milk fat, milk having nominally 0.5 wt. % or less milk fat, milk being nominally fat free or skim milk, or a combination thereof.

2. The dairy product of clause 1, wherein the dairy product comprises an element or combination of elements selected from the group consisting of:

wherein the sweetened dairy composition comprises from 8 to 15 wt. %, 8 to 14 wt. % or 8 to 11 wt. % milk solids, non-fat;

wherein the dairy product comprises a product formulation, wherein the product formulation comprises the sweetened dairy composition and at least one additional ingredient, optionally wherein the product formulation comprises 3 to 95, 3 to 10.5, or 10.5 to 95 wt. % milk solids, non-fat;

wherein the sweetened dairy composition comprises no more than a limited concentration of at least one compound contributing to an off-flavor, optionally, wherein the at least one compound is selected from the group consisting of: peptides, amino acids, and a combination thereof,

wherein the sweetened dairy composition comprises 8 to 15 wt. %, 8 to 14 wt. % or 8 to 11 wt. % milk solids, non-fat and milk solids derived from the milk solids, non-fat in the starting dairy composition used to make the sweetened dairy composition;

wherein the sweetened dairy composition comprises at least about 0.0, 0.1, 0.2, 0.3, 0.4, 0.49, 0.5, 1.0, 1.5, 2.0, 2.5, 3.0, or 3.5 wt. % fat, no more than about 5.0, 4.8, 4.5, 4.0, 3.5, 3.0, 2.5, 2.0, 1.5, 1.0, 0.5, 0.49, 0.4, 0.3, or 0.2 wt. % fat, 0.8 to 1.2 wt. % fat, or a combination thereof;

wherein the sweetened dairy composition, product formulation, the dairy product, or a combination thereof comprises at least 0.001, 0.1, 0.2, 0.25, 0.3, 0.4, 0.49 0.5, 1.0, 1.5, 2.0, 2.5 or 3.0 wt. % added sweetener (e.g., non-nutritive sweeteners, nutritive sweeteners, sugar, sucrose, fructose, glucose, xylitol, steviol glycosides, or a combination thereof), no more than 7.0, 5.0, 3.0, 2.5, 2.0, 1.5, 1.0, 0.75, 0.5, 0.49, 0.4, 0.3, 0.25 0.2, 0.1 or 0.001 wt. % added sweetener, no added sweetener, or a combination thereof;

wherein the sweetened dairy composition, the dairy product, or a combination thereof is at a temperature of no more than 25, 20, 15, 10, 9, 8, 7, 6, 5, 4, 3, 2, or 1° C., at a temperature of at least 0, 1, 2, 3, 4, or 5° C., or a combination thereof;

wherein the dairy product comprises a package for the sweetened dairy composition with optionally at least one additional ingredient or additional ingredients, optionally wherein the package is an end-user package, optionally wherein the package comprises a label, optionally wherein the label comprises a brand name for the dairy product, a sell-by date, nutrition information for the dairy product, serving size for the dairy product, calories per serving of the dairy product, fat per serving of the dairy product, carbohydrates per serving of the dairy product, protein per serving of the dairy product, vitamins per serving of the dairy product, minerals per serving of the dairy product, a listing of ingredients in the dairy product, or a combination thereof;

wherein the sweetened dairy composition is a powdered sweetened dairy composition comprising 90 to 100, 92.5 to 97.5, 93 to 97, 94 to 96 or about 95 wt. % MSNF, comprising 0 to 5, 0 to 4, 0 to 3, 0 to 2 or 0 to 1 wt. % water, or a combination thereof;

wherein the sweetened dairy composition comprises a sweetness equivalent to the sweetness of a sweetened starting dairy composition comprising 0.25 to 0.75 wt. % sucrose, wherein the sweetened starting dairy composition consists of the sucrose and either (i) a starting composition from which the sweetened dairy composition is made by lactase-catalyzed hydrolysis of lactose or (ii) a composition equivalent to the starting composition;

wherein the sweetened dairy composition is a powdered sweetened dairy composition, and wherein the sweetened dairy composition is at 0 to 25, 5 to 25, 10 to 25, 15 to 22, or 18 to 20° C.;

wherein the sweetened dairy composition is a powdered sweetened dairy composition, wherein the dairy product comprises a hydrated, powdered sweetened dairy composition, optionally wherein the dairy product comprises a product formulation comprising the hydrated, powdered sweetened dairy composition, optionally wherein the product formulation comprises at least 80 or 85 wt. % water, comprises no more than 85 or 90 wt. % water, or a combination thereof;

wherein the sweetened dairy composition is a powdered sweetened dairy composition, wherein the powdered sweetened dairy composition makes up 10 to 55 wt. % of the powdered sweetened dairy composition; optionally wherein the dairy product comprises an end-user package that contains the powdered sweetened dairy composition in a hydrated or non-hydrated form; optionally wherein the sweetened dairy composition (e.g., in the form of a powder) is configured to be stored at a temperature of 20 to 36° C.;

wherein the hydrated sweetened dairy composition has a sweetness greater than or equal to the sweetness of a first mixture comprising 99.5 g milk and 0.5 g added sucrose and a sweetness less than or equal to the sweetness of a second mixture comprising 95 g milk and 5 g added sucrose; wherein the sweetness is measured by a taste panel (e.g., using Quantitative Descriptive Analysis (QDA)® and Principle Components Analysis (PCA)); optionally wherein the taste panel consists of 10 members and conducts a taste test on 3 samples each of the hydrated sweetened dairy composition, the first mixture and the second mixture; wherein the taste panel unaware of the identity of the 9 samples; wherein the samples are presented in random order to each member of the taste panel; and wherein each member of the taste panel ranks the 9 samples in order of sweetness by assigning an integer number from 1 to 10 to each of the 9 samples to act as a rank of each of the samples with respect to increasing sweetness from 1 to 10, except that if a member of the taste panel perceives that multiple samples have the same sweetness then the member tentatively assigns one of several adjacent integer numbers to each of the multiple samples and then reassigns to each of the multiple samples a number that is the average of the adjacent integer numbers so that the average is used as the rank of each of the multiple samples having the same perceived sweetness, wherein an overall numerical average sweetness rank is calculated for each of the hydrated sweetened dairy composition, the first mixture, and the second mixture using all the respective rankings from all members of the taste panel; wherein the overall numerical average sweetness rank of each of the hydrated sweetened dairy composition, the first mixture, and the second mixture are compared to determine that the hydrated sweetened dairy composition has a sweetness that is greater than or equal to the sweetness of the first mixture and less than or equal to the sweetness of the second mixture;

wherein each component of the sweetened dairy composition is derived from milk, excepting the water, lactase, and any added sweetener;

wherein the sweetened dairy composition has a pH equal to 6 to 8, 6.5 to 7.5 or 6.75 to 7. 25;

wherein the dairy product comprises an acidified sweetened dairy composition having a pH of less than 4.6, 4.5, 4.4, 4.3, 4.2, 4.1 or greater than 3.6, 3.7, 3.8, 3.9 or 4.0;

wherein the dairy product comprises an acidified sweetened dairy composition comprising probiotics L. acidophilus, L. reuteri, Bifidobacteria, probiotics species of L. lactis or a combination thereof.

wherein the sweetened dairy composition has a glycemic index (GI) equal to less than 55, or no more than 55, 50, 45, 41, 40, 35, or 32, or equal to 32-55, 32-50, 32-45, 32-41, 32-40, or 32-35;

wherein the dairy product comprises (i) at least a portion of a first reference dairy composition, wherein the at least a portion has been subject to lactase-catalyzed lactose-hydrolysis and (ii) optional added ingredients at specified concentrations, wherein the dairy product is sweeter than a comparative sample comprising (i) a second potion of the first reference dairy composition that has not been subjected to lactase-catalyzed lactose-hydrolysis and (ii) the optional added ingredients at the specified concentrations;

wherein the dairy product comprises (i) a first portion of a first reference dairy composition, wherein the first portion has been subject to lactase-catalyzed lactose-hydrolysis and (ii) optional added ingredients at specified concentrations, wherein a second reference dairy composition comprises: (i) a second portion of the first reference dairy composition, wherein the second portion has been subject to lactase-catalyzed lactose-hydrolysis and (ii) the optional added ingredients present in the dairy product at the specified concentrations; wherein the lactase-catalyzed lactose-hydrolysis of the first portion and the second portion are equivalent and proceed using the same controlled parameters, except that the lactose-hydrolysis reaction of the second portion runs to a greater extent completion (e.g., greater than 80, 81, 82, 83, 84, 85, 90, or 95 wt.% and up to 100 wt. % completion based on mass of lactose converted to glucose and galactose) to provide the second reference dairy composition when compared to the lactose-hydrolysis reaction of the first portion, and optionally wherein the dairy product provides a more optimum overall sensorial experience than the second reference dairy composition;

wherein relative sweetness between two compositions is measured by (i) providing 3 samples of each composition to each human on a taste panel comprising 10 humans, (ii) asking each human on the taste panel to select the three sweetest samples of the samples provided, (iii) tallying the total number of times that each composition was selected as one of the three sweetest compositions, wherein the composition selected the greatest number of times by the whole taste panel is the sweeter composition;

wherein the sweetened dairy composition provides 80 to 95 wt. % of the dairy product, optionally wherein the dairy product comprises an end-user package that contains the sweetened dairy composition; optionally wherein the sweetened dairy composition is configured to be stored at a temperature of 4 to 36° C.; optionally wherein the sweetened dairy composition is configured to be sold to a consumer at a temperature of 4 to 36° C.; optionally wherein the sweetened dairy composition is configured to be consumed at a temperature of 4 to 36° C.;

wherein the sweetened dairy composition provides 45 to 55 wt. % of the dairy product; optionally wherein the sweetened dairy composition is configured to be stored at a temperature of 4 to 36° C.; optionally wherein the sweetened dairy composition is configured to be sold to a consumer at a temperature of 4 to 36° C.; optionally wherein the sweetened dairy composition is configured to be consumed at a temperature of 4 to 36° C.; and

wherein the sweetened dairy composition provides 45 to 55 wt. % of the dairy product; optionally wherein the sweetened dairy composition is configured to be stored at a temperature of 0 to 4° C.; optionally wherein the sweetened dairy composition is configured to be sold to a consumer at a temperature of 0 to 4° C.; optionally wherein the sweetened dairy composition is configured to be consumed at a temperature of 0 to 4° C.

3. A flavored dairy product comprising a sweetened dairy composition, the flavored dairy product comprising:

the dairy product of clause 1 or 2;
wherein the flavored dairy product comprises the sweetened dairy composition of clause 1 or clause 2 and at least one additional ingredient, and optionally wherein the flavored dairy product comprises at least 80 or 85 wt. % water, comprises no more than 85 or 90 wt. % water, or a combination thereof.

4. The flavored dairy product of clause 3, wherein the flavored dairy product comprises an element or a combination of elements selected from the group consisting of:
90 to 100, 92.5 to 97.5, 93 to 97, 94 to 96 or about 95 wt. % MSNF, thereby providing a powdered flavored sweetened dairy composition;
0 to 5, 0 to 4, 0 to 3, 0 to 2 or 0 to 1 wt. % water, thereby providing a powdered flavored sweetened dairy composition;
70 to 85 wt. % water, thereby providing a hydrated flavored sweetened dairy product;
at least 80 or 85 wt. % water, no more than 85 or 90 wt. % water, or a combination thereof, thereby providing a hydrated flavored sweetened dairy composition;
wherein the at least one additional ingredient is selected from the group consisting of:
   a flavor, a plurality of flavors, a natural flavor, a stabilizer, a food acid (e.g., citric acid, malic acid), skim milk powder, whey powder, milk proteins, sugar, sucrose, fruit, fruit preparation (or concentrate), cocoa, cocoa powder, chocolate, or a combination thereof;
   a set of ingredients configured to provide a product formulation intended for consumption when added to the sweetened dairy composition;
   0.5 to 2.5, 0.5 to 1.5, 0.75 to 1.25 or about 1 wt. % Cocoa;
   at least 2, 4, 6, 8, or 10 wt. % fruit preparation (e.g., strawberry puree or concentrate), no more than 4, 6, 8, 10 or 15 wt. % fruit preparation, about 4 to 10 wt. % fruit preparation, or a combination thereof;
   at least 2, 3, 4 or 5 wt. % grain, no more than 3, 4, 5, 6, 7 or 8 wt. % grain, 4 to 5 wt. %, or a combination thereof;
   at least 5, 8, 10, or 12 wt. % of a first ingredient blend, no more than 8, 10, 12 or 15 wt. % of an ingredient blend, or a combination thereof, wherein the ingredient blend comprises 0.5 to 2.5 wt. % Cocoa (e.g., 1 wt. % Cocoa), 2 to 5 wt. % grain (e.g., 4-5 wt. % grain), and 2 to 4 wt. % sugar; and
   at least 5, 8, 10, 12 or 15 wt. % of a second ingredient blend, no more than 8, 10, 12, 15 or 20 wt. % of an ingredient blend, or a combination thereof, wherein the ingredient blend comprises at least 2, 4, 6 or 8 wt. % fruit, no more than 4, 6, 8 or 10 wt. % fruit preparation, 4 to 10 wt. % fruit preparation, or a combination thereof, 2 to 5 wt. % grain (e.g., 4-5 wt. % grain), and 2 to 4 wt. % sugar.

5. A method for increasing a sweetness of a starting dairy composition (e.g., without adding a sweetener, by modifying a component inherent in milk and present in the starting dairy composition, or a combination thereof), thereby providing a dairy product comprising a sweetened dairy composition, the method comprising:

providing 0102 the starting dairy composition (e.g., milk) comprising lactose;

hydrolyzing 0103 the lactose in the starting dairy composition in a lactase-catalyzed hydrolysis reaction that converts lactose to glucose and galactose; and

deactivating 0112 the lactase-catalyzed hydrolysis reaction before completion, thereby providing the sweetened dairy composition with a lactose percent conversion equal to at least 43, 44, 45, 46, 47, 48, 49, 50, 51, 52, 53, 54, 55, 56, 57, 58, 59, 60, 61, 62, 63, 64 or 65 wt. %, no more than 81, 80, 79, 78, 77, 76, 75, 74, 73, 72, 71, 70, 69, 68, 67, 66 or 65 wt. %, or a combination thereof, or equal to 43 to 81 wt. % or 45 to 80 wt. % or 46 to 80 wt. %.

6. The dairy product of clause 1 or 2, the flavored dairy product of clause 3 or 4, or the method of clause 5, wherein the dairy product, the flavored dairy product, or the method is characterized by an element or combination of elements selected from the group consisting of:

wherein the lactose hydrolysis 0103 comprises adding 0104 a lactase-containing composition (e.g., lactase) to the starting dairy composition to provide a hydrolysis reagent composition comprising the starting dairy composition and the lactase-containing composition; optionally wherein the hydrolysis reagent composition comprises at least 0.01, 0.02, 0.03, 0.04, 0.05, or 0.1 wt. % lactase-containing composition, comprises no more than 0.15, 0.14, 0.13, 0.12, 0.11, 0.1, 0.09 or 0.08 wt. % lactase-containing composition, comprises 0.01 to 1.0, 0.01 to 0.15, or 0.02 to 0.08 wt. % lactase-containing composition, or a combination thereof);

wherein the hydrolysis reagent composition comprises (i) at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition; (ii) no more than 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition; or (iii) a combination thereof;

wherein the lactase-containing composition comprises (i) at least 1, 2, 3, 4, 5, 6, 7, 8 or 9 wt. % lactase; (ii) no more than 10, 9, 8, 7, 6, 5, 4, 3 or 2 wt. % lactase; or (iii) a combination thereof;

wherein the hydrolysis reagent composition comprises (i) at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase; (ii) no more than 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase; or a combination thereof;

wherein the lactase-containing composition has an enzyme activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/mL at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/mL at 25 ° C.; or a combination thereof;

wherein the lactase-containing composition has an enzyme activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/mL at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/mL at 25° C.; or a combination thereof;

wherein the lactase-containing composition has an enzyme activity equal to at least 2,500, 3,000, 4,000, 5,000, 6,000, 7,000, 8,000, 9,000, 10,000, 15,000, 20,000, 25,000, 30,000, 25,000, 40,000, 45,000, 50,000, 55,000, or 60,000 U/g at 25° C.; no more than 65,000, 60,000, 55,000, 50,000, 45,000, 40,000, 35,000, 30,000, 25,000, 20,000, 15,000, 10,000, 9,000, 8,000, 7,000, 6,000, 5,000, 4,000, or 3,000 U/g at 25° C.; or a combination thereof;

wherein the lactase-containing composition has an enzyme activity equal to an activity equal to at least 41,675, 50,010, 66,680, 83,350, 100,020, 116,690, 133,360, 150,030, 166,700, 250,050, 333,400, 416,750, 500,100, 583,450, 666,800, 833,500, 916,850, or 1,000,200 nkat/g at 25° C.; no more than 1,083,550, 1,000,200, 916,850, 833,500, 666,800, 583,450, 500,100, 416,750, 333,400, 250,050, 166,700, 150,030, 133,360, 116,690, 100,020, 83,350, 66,680, or 50,010 nkat/g at 25° C.; or a combination thereof;

wherein 1 enzyme unit (U) is the amount of lactase enzyme that catalyzes the conversion of 1 micro-mole of lactose per minute at 25° C., and at a pH value and lactose concentration that provides the maximum lactose hydrolysis rate for the lactase enzyme;

wherein 1 katal (kat) is the amount of lactase enzyme that catalyzes the conversion of 1 mole of lactose per second at 25° C., and at a pH value and lactose concentration that provides the maximum lactose hydrolysis rate for the lactase enzyme;

wherein the lactase is a beta-D-galactosidase;

wherein the lactase-containing composition has a total side activity that is no more 0.2, 0.1, 0.09, 0.08, 0.07, 0.06, 0.05, 0.04, 0.03, 0.02, 0.01, 0.001, 0.0001, 0.00001, 0.000001, or 0.0000001 times, and optionally down to 0 times, the lactase enzyme activity of the lactase-containing composition, wherein the total side activity is the sum of all enzyme activities for any enzymes in the lactase-containing composition that catalyze a reaction that is not lactose hydrolysis, and wherein both the enzyme activity and side activity are measured at 25° C., and at a pH value and lactose concentration that provides the maximum lactose hydrolysis rate for the lactase in the lactase-containing composition;

wherein the lactose hydrolysis step 0103 comprises providing 0106 the hydrolysis reagent composition at a hydrolysis temperature within a hydrolysis temperature range (e.g., equal to 1 to 10, 4 to 7 or 4 to 6° C.; at least 1, 2, 3, 4, 5, 6, 7, 8 or 9° C., no more than 10, 9, 8, 7, 6, 5, 4, 3, 2 or 1° C., or a combination thereof);

wherein the hydrolyzing 0103 lactose comprises maintaining 0110 the hydrolysis reagent composition at the hydrolysis temperature within the hydrolysis temperature range for a hydrolysis reaction time, wherein the hydrolysis reaction time is effective to provide the sweetened dairy composition with the desired lactose percent conversion;

wherein the deactivating 0112 the lactase-catalyzed hydrolysis reaction comprises deactivating the lactase (e.g., by heating the sweetened dairy composition to (i) at least 60, 61, 62, 63, 64, 65, 66, 67, 68, 69, 70, 71, 72, 73, 74, 75, 76, 77, 78, 79, 80, 81, 82, 83, 84, 85, 86, 87, or 88° C., (ii) no more than 105, 100, 95, 90, 89, 88, 87, 86, 85, 84, 83, 82, 81, 80, 79, 78, 77, 76, 75, 74, 73, 72, 71, 70, 69, 68, 67, 66, 65, 64, or 63° C., or (iii) a combination thereof; and optionally maintaining the sweetened dairy composition within a selected temperature range or at a selected temperature for (i) at least 0.5, 1, 2, 3, 4, 5, 6, 7, 8, 9, 10, 20, 25, 30, 35, 40 or 60 seconds, (ii) at least 1, 2, 3, 4, 5, 6, 7, 8, 9, 10, 15, 20, 25, or 30 minutes, (iii) no more than 35, 30, 25, 20, 15, 10, 9, 8, 7, 6, 5, 4, 3, 2 or 1 minutes, (iv) no more than 60, 55, 50, 45, 40, 35, 30, 25, 20, 15, 10, 9, 8, 7, 6, 5, 4, 3, 2, 1.5 or 1 seconds, (v) for 25 to 35 minutes, for 20-40 or 25-35 seconds, or for 0.5 to 1.5 seconds, or (vi) a combination thereof) to stop the lactase-catalyzed hydrolysis of the lactose, thereby providing the dairy composition with the lactose percent conversion;

wherein the method comprises adding at least one additional ingredient to the sweetened dairy composition so that the dairy product comprises the at least one additional ingredient, optionally wherein the at least one additional ingredient is selected from sugar, sucrose, flavor, fruit, fruit preparation, cocoa, chocolate, a flavor, a plurality of flavors, natural flavor, stabilizer, a food acid, or a combination thereof;

wherein the method comprises providing the sweetened dairy composition in the form of a powder, thereby providing a powdered sweetened dairy composition;

wherein the starting dairy composition comprises:
an energy concentration equal to 43 kcal per 100 g of the starting dairy composition within an energy tolerance, wherein the energy tolerance is +/−30, 25, 20, 15, 10, 9, 8, 7, 6, 5, 4, 3, 2, or 1% of 43 kcal per 100 g of the starting dairy composition;
a protein concentration providing 3.5 wt. % of the starting dairy composition within a protein tolerance, wherein the protein tolerance is +/−30, 25, 20, 15, 10, 9, 8, 7, 6, 5, 4, 3, 2, or 1% of 3.5 wt. % of the starting dairy composition;
a fat concentration providing 0 to 3.5, 0 to 2, 1 to 3, or 2.5 to 4.5 wt. % of the starting dairy composition;
a fat concentration providing 1.0 wt. % of the starting dairy composition within a fat tolerance, wherein the fat tolerance is +/−30, 25, 20, 15, 10, 9, 8, 7, 6, 5, 4, 3, 2, or 1% of 1.0 wt. % of the starting dairy composition;
a lactose concentration providing 2.0 to 6.0 wt. %, 4.0 to 6.0 wt. %, 4.5 to 5.5 wt. %, or 4.6 to 5.3 wt. % of the starting dairy composition;
a lactose concentration providing 5.0 wt. % of the starting dairy composition within a lactose tolerance, wherein the lactose tolerance is +/−30, 25, 20, 15, 10, 9, 8, 7, 6, 5, 4, 3, 2, or 1% of 5.0 wt. % of the starting dairy composition;
a glucose concentration providing 0.0 wt. % of the starting dairy composition within a glucose tolerance, wherein the glucose tolerance is +0.5, 0.4, 0.3, 0.25, 0.20, 0.15, 0.10, 0.09, 0.08, 0.07, 0.06, 0.05, 0.04, 0.03, 0.02, 0.01 or 0.00 wt. % of the starting dairy composition;
a galactose concentration providing 0.0 wt. % of the starting dairy composition within a galactose tolerance, wherein the galactose tolerance is +0.5, 0.4, 0.3, 0.25, 0.20, 0.15, 0.10, 0.09, 0.08, 0.07, 0.06, 0.05, 0.04, 0.03, 0.02, 0.01 or 0.00 wt. % of the starting dairy composition;
a MSNF concentration equal to 3.5 to 12 wt. %, 8 to 15 wt. % or 8 to 14 wt. %;
a MSNF concentration equal to 9.3 wt. % of the starting dairy composition within a MSNF tolerance, wherein the MSNF tolerance is +/−30, 25, 20, 15, 10, 9, 8, 7, 6, 5, 4, 3, 2, or 1% of 9.3 wt. % of the starting dairy composition; or
a combination thereof;

wherein the starting dairy composition comprises milk from a mammal (e.g., bovine milk), optionally, wherein the milk is pasteurized milk, whole milk, reduced-fat milk, milk having nominally 3.5 wt. % milk fat, milk having nominally 2 wt. % milk fat, milk having nominally 1 wt. % milk fat, milk having nominally 0.5 wt. % or less milk fat, milk being nominally fat free or skim milk, or a combination thereof;

wherein the starting dairy composition comprises milk from a single mammal species (e.g., bovine milk), optionally, wherein the milk is pasteurized milk, whole milk, reduced-fat milk, milk having nominally 3.5 wt. % milk fat, milk having nominally 2 wt. % milk fat, milk having nominally 1 wt. % milk fat, milk having nominally 0.5 wt. % or less milk fat, milk being nominally fat free or skim milk, or a combination thereof;

wherein the starting dairy composition comprises milk from one or more bovine mammal species, optionally, wherein the milk is pasteurized milk, whole milk, reduced-fat milk, milk having nominally 3.5 wt. % milk fat, milk having nominally 2 wt. % milk fat, milk having nominally 1 wt. % milk fat, milk having nominally 0.5 wt. % or less milk fat, milk being nominally fat free or skim milk, or a combination thereof;

wherein the starting dairy composition is provided at the hydrolysis temperature, optionally so that no heating or cooling is required for providing 0106 the hydrolysis reagent composition at the hydrolysis temperature;

wherein the dairy product is the dairy product of clause 1 or 2;

wherein the hydrolysis reaction time equal to (i) at least 1, 2, 3, 4, 5, 6, 7, 8, 9, 10, 11, 12, or 13 hours, (ii) no more than 14, 13, 12, 11, 10, 9, 8, 7, 6, 5, 4, 3 or 2 hours, or (iii) a combination thereof.

wherein the hydrolysis reaction time is selected from the group consisting of:
a hydrolysis reaction time sufficient to convert at least 43, 44, 45, 46, 47, 48, 49, 50, 51, 52, 53, 54, 55, 56, 57, 58, 59, 60, 61, 62, 63, 64 or 65 wt. %, no more than 81, 80, 79, 78, 77, 76, 75, 74, 73, 72, 71, 70, 69, 68, 67, 66 or 65 wt. %, or a combination thereof, of the lactose to glucose and galactose;
a hydrolysis reaction time sufficient to convert 40 to 80 wt.% (e.g., 45 to 80, 46 to 80, 47 to 80, 48 to 80, 50 to 77, 50 to 70, or 60 to 70 wt. %) of the lactose to glucose and galactose;
a hydrolysis reaction time within a hydrolysis reaction time range equal to 1-10, 1-6, 1-3, 2-5, 3-8, 3-6, or 4-10, hours while the lactase enzymatically catalyzes the hydrolysis of the lactose to glucose and galactose;
a hydrolysis reaction time sufficient to convert 40-65, 45-60 or 50-55 wt. % of the lactose to glucose and galactose, wherein the lactase comprises beta-D-galactosidase produced from a selected strain of K. lactis;
a hydrolysis reaction time sufficient to convert 66-80 or 70-76 wt. % of the lactose to glucose and galactose, wherein the lactase comprises a beta-D-galactosidase produced from a selected strain of K. lactis;
a hydrolysis reaction time sufficient to convert 50-80, 50-79, 60-77, or 65-70 wt. % of the lactose to glucose and galactose, wherein the lactase comprises a yeast neutral lactase beta-D-galactosidase produced from a selected strain of K. lactis; and
a combination thereof;

wherein the lactase enzyme is beta-galactosidase that hydrolyzes terminal non-reducing beta-D-galactosides releasing beta-D-galactose residues; wherein the sweetened dairy composition provides 80 to 95 wt. % of the dairy product, optionally wherein the dairy product comprises an end-user package that contains the sweetened dairy composition; optionally wherein the sweetened dairy composition is stored at a temperature of 4 to 36° C.; optionally wherein the sweetened dairy composition is sold to a consumer at a temperature of 4 to 36° C.; optionally wherein the sweetened dairy composition is consumed at a temperature of 4 to 36° C.;

wherein the sweetened dairy composition comprises a sweetness equivalent to the sweetness of a sweetened starting dairy composition comprising 0.25 to 0.75 wt. % sucrose, wherein the sweetened starting dairy composition consists of the sucrose and either (i) the starting composition from which the sweetened dairy composition is made by lactase-catalyzed hydrolysis of lactose or (ii) a composition equivalent to the starting composition;

wherein the sweetened dairy composition provides 45 to 55 wt. % of the dairy product; optionally wherein the sweetened dairy composition or a dairy product comprising the sweetened dairy composition has been heat treated (e.g., subject to a UHT process); optionally wherein the sweetened dairy composition or dairy product comprising the sweetened dairy composition is stored at a temperature of 4 to 36° C.; optionally wherein the sweetened dairy composition or a dairy product comprising the sweetened dairy composition is sold to a consumer at a temperature of 4 to 36° C.; optionally wherein the sweetened dairy composition or dairy product comprising the sweetened dairy composition is consumed at a temperature of 4 to 36° C.;

wherein the sweetened dairy composition provides 45 to 55 wt. % of the dairy product; optionally wherein the sweetened dairy composition is stored at a temperature of 0 to 4° C.; optionally wherein the sweetened dairy composition is sold to a consumer at a temperature of 0 to 4° C.; optionally wherein the sweetened dairy composition is consumed at a temperature of 0 to 4° C.; and

wherein the dairy product comprises a product formulation, wherein the sweetened dairy composition is a powdered sweetened dairy composition, and wherein the powdered sweetened dairy composition makes up 10 to 55 wt. % of the a product formulation; optionally wherein the dairy product comprises an end-user package that contains the powdered sweetened dairy composition in a hydrated or non-hydrated form; optionally wherein the sweetened dairy composition is stored at a temperature of 20 to 36° C.; optionally wherein the sweetened dairy composition is sold to a consumer at a temperature of 20 to 36° C.; and optionally wherein the sweetened dairy composition is consumed at a temperature of 20 to 36° C.

7. A method for making the flavored dairy product of clause 3 comprising a sweetened dairy composition, the method comprising:

making the dairy product according to clause 5 or 6; and

a step or combination of steps selected from the group consisting of:
adding 0114 the at least one additional optional ingredient of clause 3 or some portion thereof (e.g., sugar, or sucrose) to the starting dairy composition before lactase-catalyzed hydrolysis of the lactose in the starting dairy composition; and
adding 0114 the at least one additional ingredient of clause 3 to the sweetened dairy composition of clause 1 or 2 after lactase-catalyzed hydrolysis of the lactose in the starting dairy composition.

8. The method of clause 7, wherein the flavored dairy composition comprises an element or combination of elements selected from the group of elements listed in clause 4, thereby providing the flavored sweetened dairy composition of clause 4.

9. A method for making a dairy product comprising a powdered dairy composition, the method comprising:
making the dairy product comprising a sweetened dairy composition according to clause 5 or 6 or the flavored dairy product comprising a sweetened dairy composition according to clause 7 or 8;
providing 0116 the sweetened dairy composition of clause 5 or 6 or the flavored dairy product of clause 7 or 8 in the form of a powder, thereby providing a powdered sweetened dairy composition of clause 2.

10.The method for making a dairy product of clause 9, wherein providing 0116 the dairy product comprising the sweetened dairy composition of clause 5 or 6 or the flavored dairy product of clause 7 or 8 in the form of a powder comprises an element or combination of elements selected from the group consisting of:
spray-drying the sweetened dairy composition or the flavored sweetened dairy composition to provide a spray-dried, sweetened dairy composition or spray-dried, flavored dairy product in the form of a powder;
spray-drying the sweetened dairy composition or the flavored dairy product to provide a spray-dried, sweetened dairy composition or spray-dried, flavored dairy product and then granulating the spray-dried, sweetened dairy composition or the spray-dried, flavored dairy product to provide a granulated, spray-dried, sweetened dairy composition or a granulated, spray-dried, flavored dairy product in the form of a powder;
roller-drying the sweetened dairy composition or the flavored sweetened dairy composition to provide a roller-dried, sweetened dairy composition or roller-dried, flavored dairy product in the form of a powder;
roller-drying the sweetened dairy composition or the flavored dairy product to provide a roller-dried, sweetened dairy composition or roller-dried, flavored dairy product and then granulating the roller-dried, sweetened dairy composition or the roller-dried, flavored dairy product to provide a granulated, roller-dried, sweetened dairy composition or a granulated, roller-dried, flavored dairy product in the form of a powder;
drying the sweetened dairy composition or the flavored dairy product to provide a dried, sweetened dairy composition or a dried, flavored dairy product in the form of a powder;
granulating the sweetened dairy composition or the flavored dairy product to provide a granulated, sweetened dairy composition or a granulated, flavored dairy product in the form of a powder;
drying the sweetened dairy composition or the flavored dairy product to provide a dried, sweetened dairy composition or a dried, flavored dairy product and then granulating the dried, sweetened dairy composition or the dried, flavored dairy product to provide a granulated sweetened dairy composition or granulated, dried, flavored dairy product in the form of a powder; and optionally milling the powder to provide a milled powder, granulating the powder to provide a granulated flour, agglomerating the powder to provide an agglomerated powder, agglomerating the milled powder to provide an agglomerated milled powder, agglomerating the granulated powder to provide an agglomerated granulated powder, or a combination thereof; and
wherein the D[4,3] mean diameter (also known as volume mean moment diameter or De Brouckere mean diameter) of particles in the powder is equal to 50 to 150, 75 to 125, 80 to 120, 85 to 115, 90 to 110, or about 100 micrometers; and wherein the powder is agglomerated to provide larger particles with a mean diameter of 200-800 micrometers and/or agglomerated (e.g., granulated) particles wherein the D[4,3] mean diameter (also known as volume mean moment diameter or De Brouckere mean diameter) of particles in the powder is equal to 500 to 1500 micrometers.

11.A dairy product made according to the method of any one of clauses 5 to 10, optionally wherein the dairy product is according to clause 1, 2 or 6, or the flavored dairy product according to clause 3 or 4.

12. A dairy product comprising a fermented sweetened dairy composition, the fermented sweetened dairy composition comprising:

a mass ratio of lactose:glucose equal to more than 0.0:3.0 and up to 1.0:1.0 (e.g., from 0.01:3.0 to 1.0:1.0, or from 0.01:2.4 to 1.0:1.0, or from 0.1:2.4 to 1.0:1.0); and

a mass ratio of lactose:galactose equal to more than 0.0:3.0 and up to 1.0:1.0 (e.g., from 0.01:3.0 to 1.0:1.0, or from 0.01:2.7 to 1.0:1.0, or from 0.1:2.7 to 1.0:1.0);

optionally wherein the fermented sweetened dairy composition comprises at least 0, 0.01, 0.1, or 0.2 wt. % lactose, no more than 1.0, 0.9, 0.8, 0.7, 0.6, 0.5, 0.4, 0.3, 0.2, 0.1 wt. % lactose, or 0 to 1.0, 0.01 to 1.0, 0.1 to 1.0, 0.1 to 0.4, 0.1 to 0.2 wt. % lactose, or a combination thereof;

optionally wherein the fermented sweetened dairy composition comprises at least 1.0, 1.5, 2.0, 2.1, or 2.2 wt. % glucose, no more than 3.0, 2.9, 2.8, 2.7, 2.6, 2.5 or 2.4 wt. % glucose, 1.0 to 3.0, 1.0 to 2.4, 2.0 to 2.4, or 2.2 to 2.4 wt. % glucose, or a combination thereof; and

optionally wherein the fermented sweetened dairy composition comprises at least 1.0, 1.5, 2.0, 2.1, or 2.2, 2.3, 2.4, 2.5 or 2.6 wt. % galactose, no more than 3.0, 2.9, 2.8, or 2.7 wt. % galactose, 1.0 to 2.7, 2.0 to 2.7, or 2.2 to 2.7 wt. % galactose, or a combination thereof;

optionally wherein the dairy product comprises a package for the fermented sweetened dairy composition with optionally at least one additional ingredient or additional ingredients;

optionally wherein the package is an end-user package;

optionally wherein the package comprises a label; and

optionally wherein the label comprises a brand name for the dairy product, a sell-by date, nutrition information for the dairy product, serving size for the dairy product, calories per serving of the dairy product, fat per serving of the dairy product, carbohydrates per serving of the dairy product, protein per serving of the dairy product, vitamins per serving of the dairy product, minerals per serving of the dairy product, a listing of ingredients in the dairy product, a listing of live cultures in the dairy product, or a combination thereof.

13.The dairy product of clause 12, wherein the fermented sweetened dairy composition comprises:

2.5 to 10.0 wt. % protein;

0.0 to 5.0 wt. % fat;

0.01 to 1.0 wt. % lactose;

8.0 to 14.0 wt. % MSNF; or

a combination thereof.

14. The dairy product of any one of clauses 12 to 13, wherein the fermented sweetened dairy composition comprises an element or combination of elements selected from the group consisting of:

0.0 to 5.0 wt. % fat;

wherein the fermented sweetened dairy composition is provided or maintained at a temperature of 0 to 4° C.;

wherein the dairy product comprises an end-user package that contains the fermented sweetened dairy composition;

wherein the fermented sweetened dairy composition has a glycemic index (GI) equal to 14 to 40; wherein the fermented sweetened dairy composition is a fermented sweetened dairy composition comprising yogurt cultures;

wherein the fermented sweetened dairy composition has a pH of 3.6 to 4.6, 3.9 to 4.5, 4.1 to 4.6 or 4.1 to 4.5;

wherein the fermented sweetened dairy composition comprises live yogurt cultures;

wherein the fermented sweetened dairy composition has a pH equal to at least 4.1 or 4.2, no more than 4.6, 4.5, 4.4, 4.3, or 4.2, or a combination thereof; and

wherein the fermented sweetened dairy composition is yogurt.

15.The dairy product of any one of clauses 12-14, wherein the dairy product comprises a product formulation, wherein the product formulation comprises the fermented sweetened dairy composition and at least one additional ingredient, optionally wherein the dairy product comprises an element or combination of elements selected from the following group of elements:
wherein the at least one additional ingredient is a fruit preparation, grain (e.g., cereal, legume, or combination thereof) cocoa, fruit concentrate, fruit preparation, or a combination thereof; and
wherein the product formulation comprises at least 0.001, 0.1, 0.2, 0.3, 0.4, 0.49 0.5, 1.0, 1.5, 2.0, 2.5 or 3.0 wt. % of an added sweetener (e.g., non-nutritive sweeteners, nutritive sweeteners, sugar, sucrose, fructose, glucose, xylitol, steviol glycosides, or a combination thereof), no more than 7.0, 3.5, 3.0, 2.5, 2.0, 1.5, 1.0, 0.5, 0.1, 0.01, 0.001, or 0 wt. % of an added sweetener, or a combination thereof.

16. A method for providing a dairy product comprising a fermented sweetened dairy composition, the method comprising:

providing a starting dairy composition comprising lactose;

hydrolyzing lactose in the starting dairy composition in a lactase-catalyzed hydrolysis reaction that converts lactose to glucose and galactose; and

fermenting lactose in the starting dairy composition;

wherein the hydrolysis and the fermentation provide the fermented sweetened dairy composition with a lactose percent conversion equal to 80 to 100 wt. %.

17. The dairy product of any one of clauses 12-15 or the method of clause 16, wherein the dairy product or the method comprises an element or combination of elements selected from the group consisting of:

wherein the starting dairy composition is subject to pretreatment before hydrolyzing, fermenting, or hydrolyzing and fermenting the lactose in the starting dairy composition, wherein the pretreatment is selected from the group consisting of: (i) the starting dairy composition is clarified to provide a clarified composition, (ii) the starting dairy composition or the clarified composition is heated (e.g., to a temperature equal to about 50 to about 70° C., or about 55 to about 65° C.) to provide a heated composition, (iii) the starting dairy composition or the heated composition is homogenized to provide a homogenized composition, optionally wherein the homogenization occurs in two stages, optionally wherein the first stage pressure is greater than the second stage pressure, optionally wherein the first stage pressure is equal to about 180 to 200 bar gauge and the second stage pressure is equal to about 15 to 25% or 18 to 22% of the first stage pressure or about 27 to 50 bar gauge, optionally wherein the homogenization is a one-stage homogenization, optionally wherein the one-stage homogenization occurs at a pressure maintained at about 150 to about 200 bar gauge, (iv) the homogenized composition is pasteurized (e.g., at about 90 to about 95° C. and optionally for about 240 to about 540 seconds), (v) the homogenized composition is cooled to 38 to 42° C., and (vi) a combination thereof;

wherein the hydrolysis comprises adding lactase to the starting dairy composition to provide a hydrolysis reagent composition comprising the starting dairy composition and the lactase and optionally cultures; optionally wherein the hydrolysis reagent composition comprises at least 0.01, 0.02, 0.03, 0.04, 0.05, or 0.1 wt. % lactase-containing composition, comprises no more than 0.15, 0.14, 0.13, 0.12, 0.11, 0.1, % lactase-containing composition, comprises 0.01 to 1.0, 0.01 to 0.15, or % lactase-containing composition, or a combination thereof;

wherein the hydrolysis reagent composition comprises (i) at least 0.01, 0.02, 0.03, 0.04, 0.05, 0.06, 0.07, 0.08, 0.09, 0.10, 0.11, 0.12, 0.13, 0.14, 0.15, 0.2, 0.3, 0.4, 0.5, 0.6, 0.7, 0.8 or 0.9 wt. % lactase-containing composition; (ii) no more than 1.0, 0.9, 0.8, 0.7, 0.6, 0.5, 0.4, 0.3, 0.2, 0.15, 0.14, 0.13, 0.12, 0.11, 0.10, 0.09, 0.08, 0.07, 0.06, 0.05, 0.04, 0.03 or 0.02 wt. % lactase-containing composition; or (iii) a combination thereof;

wherein the lactase-containing composition comprises (i) at least 1, 2, 3, 4, 5, 6, 7, 8 or 9 wt. % lactase; (ii) no more than 10, 9, 8, 7, 6, 5, 4, 3 or 2 wt. % lactase; or (iii) a combination thereof;

wherein the hydrolysis reagent composition comprises (i) at least 0.0001, 0.0002, 0.0003, 0.0004, 0.0005, 0.0006, 0.0007, 0.0008, 0.0009, 0.0010, 0.0011, 0.0012, 0.0013, 0.0014, 0.0015, 0.002, 0.003, 0.004, 0.005, 0.006, 0.007, 0.008, 0.009, 0.010, 0.011, 0.012, 0.013, 0.014, 0.015, 0.02, 0.03, 0.04, 0.05, 0.06, 0.07, 0.08 or 0.09 wt. % lactase; (ii) no more than 0.1, 0.09, 0.08, 0.07, 0.06, 0.05, 0.04, 0.03, 0.02, 0.015, 0.014, 0.013, 0.012, 0.011, 0.010, 0.009, 0.008, 0.007, 0.006, 0.005, 0.004, 0.003, 0.002, 0.0015, 0.0014, 0.0013, 0.0012, 0.0011, 0.0010, 0.0009, 0.0008, 0.0007, 0.0006, 0.0005, 0.0004, 0.0003 or 0.0002 wt. % lactase; or a combination thereof;

wherein the lactase-containing composition has an enzyme activity equal to at least 2,000, 3,000, 4,000, or 5,000 U/mL at 25° C.; no more than 5,500, 5,000, 4,000, or 3,000 U/mL at 25° C.; or a combination thereof;

wherein the lactase-containing composition has an enzyme activity equal to at least 33,340, 50,010, 66,680, or 83,350 nkat/mL at 25 ° C.; no more than 91,685, 83,350, 66,680, or 50,010 nkat/mL at 25° C.; or a combination thereof;

wherein the lactase-containing composition has an enzyme activity equal to at least 2,000, 3,000, 4,000, or 5,000 U/g at 25° C.; no more than 5,500, 5,000, 4,000, or 3,000 U/g at 25° C.; or a combination thereof;

wherein the lactase-containing composition has an enzyme activity equal to an activity equal to at least 33,340, 50,010, 66,680, or 83,350 nkat/g at 25° C.; no more than 91,685, 83,350, 66,680, or 50,010 nkat/g at 25° C.; or a combination thereof;

wherein 1 enzyme unit (U) is the amount of lactase enzyme that catalyzes the conversion of 1 micro-mole of lactose per minute at 25 ° C., and at a pH value and lactose concentration that provides the maximum lactose hydrolysis rate for the lactase enzyme;

wherein 1 katal (kat) is the amount of lactase enzyme that catalyzes the conversion of 1 mole of lactose per second at 25° C., and at a pH value and lactose concentration that provides the maximum lactose hydrolysis rate for the lactase enzyme; optionally, wherein 1 U is equal to approximately 16.67 nkatal;
wherein the lactase-containing composition has an activity equal to 2000 to 5500 Lactase Units per gram of the lactase-containing composition, wherein one lactase unit is the quantity of enzyme that catalyzes hydrolysis to liberate 1 μmol/minute of o-nitrophenol from an o-nitrophenyl-β-D-galactopyranoside substrate at a pH of 4.5 and at a temperature equal to at least 28, 29, 30, 31, 32, 33, 34, 35, 36, 37, 38, 39, 40, 41, 42, or 43° C. and no more than 43, 42, 41, 40, 39, 38, 37, 36, 35, 34, 33, 32, 31, 30, 29, or 28° C., for example, at 37° C., optionally wherein the rate of hydrolysis is measured using a spectrophotometer;

wherein the lactase is a beta-D-galactosidase;

wherein the lactase-containing composition has a total side activity that is no more 0.2, 0.1, 0.09, 0.08, 0.07, 0.06, 0.05, 0.04, 0.03, 0.02, 0.01, 0.001, 0.0001, 0.00001, 0.000001, or 0.0000001 times, and optionally down to 0 times, the lactase enzyme activity of the lactase-containing composition, wherein the total side activity is the sum of all enzyme activities for any enzymes in the lactase-containing composition that catalyze a reaction that is not lactose hydrolysis, and wherein both the enzyme activity and side activity are measured at 25° C., and at a pH value and lactose concentration that provides the maximum lactose hydrolysis rate for the lactase in the lactase-containing composition;

wherein the fermenting step occurs as a co-reaction with the hydrolyzing step so that the hydrolysis and the fermentation overlap in time, optionally wherein the co-reaction occurs at 28 to 43° C.; at least 28, 29, 30, 31, 32, 33, 34, 35, 36, 37, 38, 39, 40, 41 or 42° C.; no more than 43, 42, 41, 40, 39, 38, 37, 36, 35, 34, 33, 32, 31, 30, or 29° C.; or a combination thereof;

wherein the fermentation comprises providing the starting dairy composition at a fermentation temperature within a fermentation temperature range equal to 28 to 43° C.; at least 28, 29, 30, 31, 32, 33, 34, 35, 36, 37, 38, 39, 40, 41 or 42° C.; no more than 43, 42, 41, 40, 39, 38, 37, 36, 35, 34, 33, 32, 31, 30, or 29° C.; or a combination thereof;

wherein the step of adding lactic acid bacteria occurs after providing the starting dairy composition within the fermentation temperature range;

wherein the fermenting comprises adding lactic acid bacteria to the starting dairy composition to produce lactic acid from the lactose in the starting dairy composition;

wherein the hydrolysis comprises providing the starting dairy composition at a hydrolysis temperature within a hydrolysis temperature range equal to 28 to 43° C.; at least 28, 29, 30, 31, 32, 33, 34, 35, 36, 37, 38, 39, 40, 41 or 42° C.; no more than 43, 42, 41, 40, 39, 38, 37, 36, 35, 34, 33, 32, 31, 30, or 29° C.; or a combination thereof;

wherein the fermentation comprises adding Lactobacillus delbrueckii subsp. Bulgaricus, Streptococcus thermophiles, or a combination thereof to the starting dairy composition to produce lactic acid from the lactose in the starting dairy composition;

wherein the fermenting continues for a time sufficient to provide the fermented sweetened dairy composition with a pH of 4.1 to 4.6;

wherein the hydrolyzing, the fermenting, a co-reaction comprising the fermenting and the hydrolyzing, or a combination thereof has a duration equal to (i) at least 1, 2, 3, 4, 5, 6, 7, 8, 9, 10, 11, 12, or 13 hours, (ii) no more than 14, 13, 12, 11, 10, 9, 8, 7, 6, 5, 4, 3 or 2 hours, or (iii) a combination thereof;

wherein the hydrolyzing, the fermenting, a co-reaction comprising the fermenting and the hydrolyzing, or a combination thereof has a duration selected to convert a desired amount of the lactose in the starting dairy composition (e.g., 80, 81, 82, 83, 84, 85, 90, 95, 96, 97, 98 or 99 wt. % and up to 100 wt. %) to glucose, galactose (e.g., via hydrolysis) and lactic acid (e.g., via fermentation); and fermenting lactose in the starting dairy composition with yogurt cultures to provide the fermented sweetened dairy composition as a yogurt;

wherein the lactase used in the hydrolyzing step and cultures used in the fermenting step are combined with the starting dairy composition to provide a hydrolysis reagent composition, wherein the hydrolysis reagent composition comprises 0.0004 to 0.008 wt. % lactase;

wherein a product composition is selected from the dairy product, the fermented sweetened dairy composition, or a combination thereof, wherein upon storing the product composition at 4-6° C. for a storage period lasting (i) at least 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days, (ii) for no more than 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8 or 7 days, or a (iii) combination thereof, the product composition has a shear stress at a shear rate of 300 s\hat{ }-1 that is at least 0.5, 1, 2, 3, 4% and no more than 5, 4, 3, 2 or 1% greater than the shear stress at a shear rate of 300 s\hat{ }-1 for a reference fermented dairy composition that is made and stored using the same process as the product composition except that no lactase has been added to the reference fermented dairy composition,

wherein a product composition is selected from the dairy product, the fermented sweetened dairy composition, or a combination thereof, wherein upon storing the product composition at 4-6° C. for a storage period lasting (i) at least 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days, (ii) for no more than 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8 or 7 days, or a (iii) combination thereof, the product composition has a shear stress equal to at least 40, 45, 50, 55, 60, 65, 70, 75, 80, or 85 Pa, no more than 90, 85, 80, 75, 70, 65, 60, 55, 50, or 45 Pa, or a combination thereof at a shear rate equal to 300 s\hat{ }-1;

wherein a product composition selected from the dairy product, the fermented sweetened dairy composition, or a combination thereof, has a pH equal to 4.2 to 4.6, wherein upon storing the product composition at 4-6° C. for a storage period lasting (i) at least 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days, (ii) for no more than 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8 or 7 days, or a (iii) combination thereof, the product composition has a live bacteria count equal to at least 10, 11, 12, 13, 14, 15, 16, 17, 18, 19 or 20 million per serving size, no more than 20, 19, 18, 17, 16, 15, 14, 13, 12, 11 or 10 million per a serving size, or a combination thereof, optionally wherein the serving size is indicated on a label, packaging, or literature for the product composition;

wherein a product composition selected from the dairy product, the fermented sweetened dairy composition, or a combination thereof, has a pH equal to 4.2 to 4.6, wherein upon storing the product composition at 4-6° C. for a storage period lasting (i) at least 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 days, (ii) for no more than 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8 or 7 days, or a (iii) combination thereof, the pH of the product composition at the end of the storage period: (a) is less than the pH of a reference fermented dairy composition at the end of the storage period wherein the reference fermented dairy composition is made and stored using the same process as the product composition except that no lactase has been added to the reference fermented dairy composition, or (b) has decreased by less than 0.25, 0.24, 0.23, 0.22, 0.21, 0.20, 0.19, 0.18, 0.17, 0.16, 0.15, 0.14, 0.13, 0.12, 0.11, or 0.10 and optionally at least 0.09, 0.10, 0.11, 0.12, 0.13, 0.14, 0.15, 0.16, 0.17, 0.18, 0.19, 0.20, 0.21, 0.22, 0.23 or 0.24 relative to the pH of the product composition at the beginning of the storage period, optionally after the storage period the product composition has a live bacteria count equal to at least 10, 11, 12, 13, 14, 15, 16, 17, 18, 19 or 20 million per serving size, no more than 20, 19, 18, 17, 16, 15, 14, 13, 12, 11 or 10 million per a serving size, or a combination thereof, optionally wherein the serving size is indicated on a label, packaging, or literature for the product composition;

wherein a product composition selected from the dairy product, the fermented sweetened dairy composition, or a combination thereof, has a pH equal to 4.2 to 4.6, wherein upon storing the product composition at 4-6° C. for a storage period lasting 28 days, the pH of the product composition at the end of the storage period has decreased by less than 0.18, 0.17, 0.16, 0.15, 0.14, 0.13, 0.12, 0.11, or 0.10 and optionally at least 0.09, 0.10, 0.11, 0.12, 0.13, 0.14, 0.15, 0.16, 0.17 or 0.18, relative to the pH at the beginning of the storage period, optionally after the storage period the product composition has a live bacteria count equal least 10, 11, 12, 13, 14, 15, 16, 17, 18, 19 or 20 million per serving size, no more than 20, 19, 18, 17, 16, 15, 14, 13, 12, 11 or 10 million per a serving size, or a combination thereof, optionally wherein the serving size is indicated on a label, packaging, or literature for the product composition; and

wherein the starting dairy composition comprises:

an energy concentration equal to 55 kcal per 100 g of the starting dairy composition within an energy tolerance, wherein the energy tolerance is +/−30, 25, 20, 15, 10, 9, 8, 7, 6, 5, 4, 3, 2, or 1% of 55 kcal per 100 g of the starting dairy composition;
a protein concentration providing 3.1 wt. % of the starting dairy composition within a protein tolerance, wherein the protein tolerance is +/−30, 25, 20, 15, 10, 9, 8, 7, 6, 5, 4, 3, 2, or 1% of 3.1 wt. % of the starting dairy composition;
a fat concentration providing 0 to 3.5, 0 to 2.5, 0 to 2, 1 to 3, 2 to 3, or 2.5 to 4.5 wt. % of the starting dairy composition;
a fat concentration providing 2.5 wt. % of the starting dairy composition within a fat tolerance, wherein the fat tolerance is +/−30, 25, 20, 15, 10, 9, 8, 7, 6, 5, 4, 3, 2, or 1% of 2.5 wt. % of the starting dairy composition;
a lactose concentration providing 2.0 to 6.0 wt. %, 4.0 to 6.0 wt. %, 4.5 to 5.5 wt. %, or 4.6 to 5.3 wt. % of the starting dairy composition;
a lactose concentration providing 5.0 wt. % of the starting dairy composition within a lactose tolerance, wherein the lactose tolerance is +/−30, 25, 20, 15, 10, 9, 8, 7, 6, 5, 4, 3, 2, or 1% of 5.0 wt. % of the starting dairy composition;
a glucose concentration providing 0.0 wt. % of the starting dairy composition within a glucose tolerance, wherein the glucose tolerance is +0.5, 0.4, 0.3, 0.25, 0.20, 0.15, 0.10, 0.09, 0.08, 0.07, 0.06, 0.05, 0.04, 0.03, 0.02, 0.01 or 0.00 wt. % of the starting dairy composition;
a galactose concentration providing 0.0 wt. % of the starting dairy composition within a galactose tolerance, wherein the galactose tolerance is +0.5, 0.4, 0.3, 0.25, 0.20, 0.15, 0.10, 0.09, 0.08, 0.07, 0.06, 0.05, 0.04, 0.03, 0.02, 0.01 or 0.00 wt. % of the starting dairy composition;
a MSNF concentration equal to 3.5 to 12 wt. %, 8 to 15 wt. % or 8 to 14 wt. %;
a MSNF concentration equal to 8.9 wt. % of the starting dairy composition within a MSNF tolerance, wherein the MSNF tolerance is +/−30, 25, 20, 15, 10, 9, 8, 7, 6, 5, 4, 3, 2, or 1% of 8.9 wt. % of the starting dairy composition; or
a combination thereof.

Although the present disclosure has provided many examples of systems, apparatuses, and methods, it should be understood that the components of the systems, apparatuses and method described herein are compatible and additional embodiments can be created by combining one or more elements from the various embodiments described herein. As an example, in some embodiments, a method described herein can further comprise one or more elements of a system described herein or a selected combination of elements from any combination of the systems or apparatuses described herein.

Furthermore, in some embodiments, a method described herein can further comprise using a system described herein, using one or more elements of a system described herein, or using a selected combination of elements from any combination of the systems described herein.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for a product, process or system, the characteristics, structure, size, shape, arrangement, or composition can also be incorporated into any other product, process or system described herein to provide additional embodiments. For example, it should be understood that the method steps described herein are exemplary, and upon reading the present disclosure, a skilled person would understand that one or more method steps described herein can be combined, omitted, re-ordered, or substituted.

Some embodiments of the disclosure use the terms sweetened dairy composition, product formulation and dairy product. As a skilled person would understand, a dairy product can comprise or be the product formulation, sweetened dairy composition, or a combination thereof. Also, as a skilled person would understand, for any embodiment of a sweetened dairy composition described herein as possessing certain properties, an additional embodiment can be created in which a dairy product or a product formulation comprising the sweetened dairy composition has the same properties as the sweetened dairy composition. For example, the dairy product can be the sweetened dairy composition. Accordingly, it is self-evident that an embodiment of the dairy product can have the same properties as the sweetened dairy composition. Additionally, even if an additional ingredient is added to the sweetened dairy composition to provide a product formulation, the additional ingredient can be selected to maintain any desired property of the sweetened dairy composition, for example, pH, glycemic index, temperature, or a combination thereof, except for the mass fraction of the sweetened dairy composition as a portion of the total mass of the dairy product. Similarly, if a product formulation is described as having certain properties herein, an additional embodiment can be created in which the sweetened dairy composition possesses the properties. For example, some ingredients can be added to a starting dairy composition after the lactose in the starting dairy composition is being hydrolyzed. In some embodiments, a product formulation can be provided by mixing the sweetened dairy composition with additional ingredients.

Some embodiments of the disclosure use the terms fermented sweetened dairy composition, product formulation and dairy product. As a skilled person would understand, a dairy product can comprise or be the product formulation, fermented sweetened dairy composition, or a combination thereof. Also, as a skilled person would understand, for any embodiment of a fermented sweetened dairy composition described herein as possessing certain properties, an additional embodiment can be created in which a dairy product or a product formulation comprising the fermented sweetened dairy composition has the same properties as the fermented sweetened dairy composition. For example, the dairy product can be the fermented sweetened dairy composition. Accordingly, it is self-evident that an embodiment of the dairy product can have the same properties as the fermented sweetened dairy composition. Additionally, even if an additional ingredient is added to the fermented sweetened dairy composition to provide a product formulation, the additional ingredient can be selected to maintain any desired property of the fermented sweetened dairy composition, for example, pH, glycemic index, temperature, or a combination thereof, except for the mass fraction of the fermented sweetened dairy composition as a portion of the total mass of the dairy product. Similarly, if a product formulation is described as having certain properties herein, an additional embodiment can be created in which the fermented sweetened dairy composition possesses the properties. For example, some ingredients can be added to a starting dairy composition after the lactose in the starting dairy composition is hydrolyzed and/or fermented. In such a situation, the fermented sweetened dairy composition can be mixed with additional ingredients and exist in the form of a product formulation.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Where language, for example, “for” or “to”, is used herein in conjunction with an effect, function, use or purpose, an additional embodiment can be provided by substituting “for” or “to” with “configured for/to” or “adapted for/to.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

As used herein, examples of “substantially” include: “more so than not,” “mostly,” and “at least 30, 40, 50, 60, 70, 80, 90, 95, 96, 97, 98 or 99%” with respect to a referenced characteristic.

As used herein, examples of “about” and “approximately” include a specified value or characteristic to within plus or minus 30, 25, 20, 15, 10, 5, 4, 3, 2, or 1% of the specified value or characteristic.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A dairy product comprising a sweetened dairy composition, the sweetened dairy composition comprising:
lactose, glucose and galactose;
wherein the mass ratio of the lactose to the glucose in the sweetened dairy composition is from 1.0:2.7 to 2.6:1.5; and
wherein the mass ratio of the lactose to the galactose in the sweetened dairy composition is 1.0:2.2 to 2.6:1.1.

2. The dairy product of claim 1, wherein the sweetened dairy composition comprises:
1.0 to 2.6 wt. % lactose;
1.5 to 2.7 wt. % glucose; and
1.1 to 2.2 wt. % galactose.

3. The dairy product of claim 1, wherein the sweetened dairy composition comprises 8 to 11 wt. % milk solids, non-fat.

4. The dairy product of claim 1, wherein the dairy product comprises a product formulation comprising the sweetened dairy composition and at least one additional ingredient.

5. The dairy product of claim 1, wherein the sweetened dairy composition has a glycemic index (GI) equal to 32-55.

6. A method for increasing a sweetness of a starting dairy composition, thereby providing a dairy product comprising a sweetened dairy composition, the method comprising:
providing a starting dairy composition comprising lactose;
hydrolyzing lactose in the starting dairy composition in a lactase-catalyzed hydrolysis reaction that converts lactose to glucose and galactose; and
deactivating the lactase-catalyzed hydrolysis reaction before completion, thereby providing the sweetened dairy composition with a lactose percent conversion equal to 46 to 80 wt. %.

7. The method of claim 6, wherein the method comprises adding at least one additional ingredient to the sweetened dairy composition so that the dairy product comprises the at least one additional ingredient, wherein the at least one additional ingredient is selected from the group consisting of cocoa powder, grain, a fruit concentrate, and a fruit preparation.

8. The method of claim 6, wherein the method comprises providing the sweetened dairy composition in the form of a powder, thereby providing a powdered sweetened dairy composition.

9. The method of claim 6, wherein the starting dairy composition comprises from 4.6 to 5.3 wt. % lactose; from 3.5 to 12.0 wt. % milk solids, non-fat, and a combination thereof.

10. The method of claim 6, wherein the starting dairy composition comprises milk from one or more species of mammals.

11. A dairy product comprising a fermented sweetened dairy composition, the fermented sweetened dairy composition comprising a mass ratio of lactose:glucose equal to 0.01:2.4 to 1.0:1.0; and a mass ratio of lactose:galactose equal to 0.01:2.7 to 1.0:1.0.

12. The dairy product of claim 11, wherein the fermented sweetened dairy composition comprises from 0 to 1.0 wt. % lactose; at least 1.0 wt. % glucose; and at least 1.0 wt. % galactose.

13. The dairy product of claim 11, wherein the fermented sweetened dairy composition comprises:
2.5 to 10.0 wt. % protein;
0.0 to 5.0 wt. % fat;
0.01 to 1.0 wt. % lactose; and
8.0 to 14.0 wt. % MSNF.

14. The dairy product of claim 11, wherein the fermented sweetened dairy composition has a glycemic index (GI) equal to 14 to 40.

15. The dairy product of claim 11, wherein the fermented sweetened dairy composition comprises yogurt cultures.

16. A method for providing a dairy product comprising a fermented sweetened dairy composition, the method comprising:
providing a starting dairy composition comprising lactose;
hydrolyzing lactose in the starting dairy composition in a lactase-catalyzed hydrolysis reaction that converts lactose to glucose and galactose;
fermenting lactose in the starting dairy composition;
wherein the hydrolysis and the fermentation provide the fermented sweetened dairy composition with a lactose percent conversion equal to 80 to 100 wt. %.

17. The method of claim 16, wherein the fermenting step occurs as a co-reaction with the hydrolysis step so that the hydrolyzing and the fermenting overlap in time.

18. The method of claim 16, wherein the fermentation comprises adding lactic acid bacteria to the starting dairy composition to produce lactic acid from the lactose in the starting dairy composition.

19. The method of claim 18 wherein the step of adding the lactic acid bacteria occurs after providing the starting dairy composition within a fermentation temperature range.

20. The method of claim 16, wherein the method comprises fermenting lactose in the starting dairy composition with yogurt cultures to provide the fermented sweetened dairy composition as a yogurt.
